(19) United States
(12) Patent Application Publication
(10) Pub. No.: US 2022/0295131 A1
(43) Pub. Date: Sep. 15, 2022

(54) SYSTEMS, METHODS, AND APPARATUSES FOR TRICK MODE IMPLEMENTATION

(71) Applicant: Comcast Cable Communications, LLC, Philadelphia, PA (US)

(72) Inventors: Rima Shah, Denver, CO (US); James Panagos, Denver, CO (US); Sivakumar Mani, Denver, CO (US); Chad Gilloth, Denver, CO (US)

(21) Appl. No.: 17/196,718

(22) Filed: Mar. 9, 2021

(51) Int. Cl. H04N 21/2668; H04N 21/258; H04N 21/239; H04N 21/845; H04N 21/6587

(52) U.S. Cl. CPC H04N 21/2668; H04N 21/25891; H04N 21/239; H04N 21/8456; H04N 21/6587

(57) ABSTRACT

Methods, systems, and apparatuses for trick mode implementation are described herein. User defined or crowd sourced trick mode information for a content item may be determined. The trick mode information may be used to generate a custom manifest file based on the source manifest for the content item and the trick mode information. The custom manifest file may include trick play automation points and an associated type of trick play operation. During playback of the content item, the type of trick play operation may be performed for a duration based on the trick play automation points.

### BACKGROUND

Viewers watching content may not want to be exposed to every aspect of the content. For example, viewers may not want to be exposed to portions of the content including commercials, violence, nudity, strong language, and/or the like. Typically, users will rely on a trick play operation, such as fast forward, to skip over such portions of content. However, viewers may still be prone to exposure to undesirable portions of the content and may even inadvertently skip other portions of the content (e.g., portions having importance to the plot of the content item). These and other considerations are addressed herein.

### SUMMARY

It is to be understood that both the following general description and the following detailed description are exemplary and explanatory only and are not restrictive, as claimed. Methods, systems, and apparatuses for trick mode implementation, including, for example, automation, signaling, data collection and management, are described herein. Users may have preferences for aspects of a content item that the user may not want to experience, such as violence, sexual content, foul language, commercials, and the like. One or more profiles associated with the content item that contain user- and/or crowd-sourced boundary points may be used to create a custom manifest file to address the user preferences. The user- and/or crowd-sourced boundary points may correspond to start/stop points within a content item on either side of any given segment of the content item that the user may wish to skip. The custom manifest file may comprise one or more trick play automation points corresponding to the boundary points. During playback of the content item, the custom manifest file enables trick play operations to automatically be performed and/or emulated according to the trick play automation points. For example, the custom manifest file may emulate a trick play operation by skipping specific segments according to the trick play automation points. The custom manifest file may be created in response to a request or trick play automation points can be added to a manifest file already in use. The trick play automation points may represent an associated trick play operation (e.g., pause, fast-forward, skip, reduce volume, mute, mute closed captions, etc.), and may be determined through crowd sourcing data, historical use data, machine learning, or may be specified by a user or a plurality of users. One or more profiles comprising the boundary points may be generated for the content item. For example, a content item may have a profile associated with skipping violent scenes and a profile associated with skipping sexual content. In operation, one or more profiles may be used to create the custom manifest file. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example environment in which the present methods and systems may operate;

FIG. 2 shows an example environment in which the present methods and systems may operate;

FIG. 3 shows an example processing flow;

FIG. 4 shows an example environment in which the present methods and systems may operate;

FIG. 5 shows a flowchart of an example method;

FIG. 6 shows a flowchart of an example method;

FIG. 7 shows a flowchart of an example method;

FIG. 8 shows a flowchart of an example method;

FIG. 9 shows a flowchart of an example method;

FIG. 10 shows a flowchart of an example method;

FIG. 11 shows an example method;

FIG. 12 shows example features of a predictive model;

FIG. 13 shows an example method;

FIG. 14 shows a block diagram of an example computing device in which the present methods and systems may operate.

### DETAILED DESCRIPTION

Before the present methods and systems are described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Described are components that may be used to perform the described methods and systems. These and other components are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all aspects of this application including, but not limited to, steps in described methods. Thus, if there are a variety of additional steps that may be performed it is understood that each of these additional steps may be performed with any specific embodiment or combination of embodiments of the described methods.

The present methods and systems may be understood more readily by reference to the following detailed description and the examples included therein and to the Figures and their previous and following description. As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, flash memory internal or removable, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

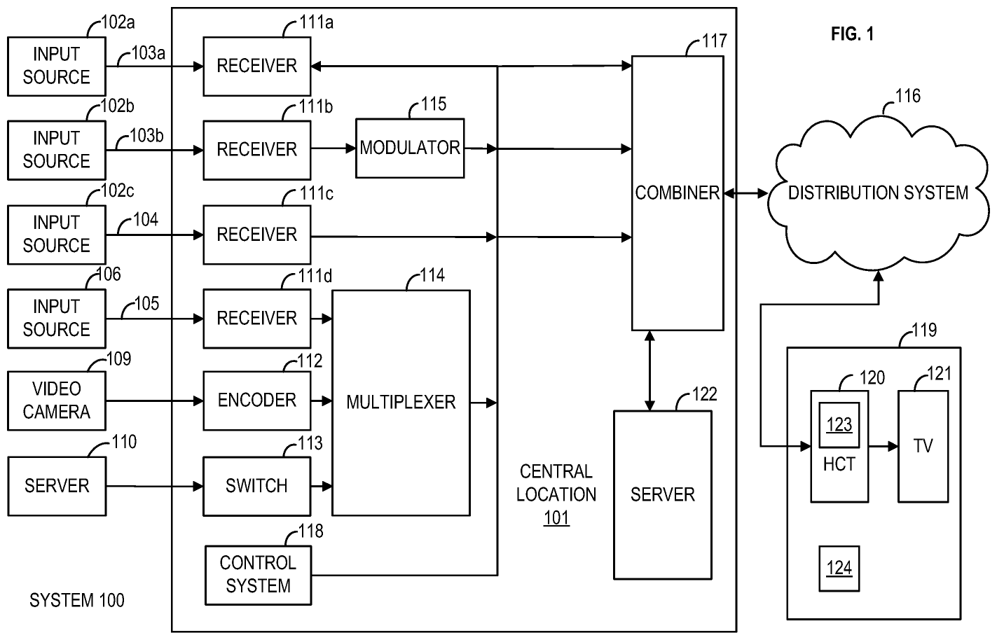

FIG. 1 illustrates various aspects of an example environment in which the present methods and systems can operate. The environment is relevant to systems and methods for trick mode automation applied to content items provided by a content provider. Those skilled in the art will appreciate that present methods may be used in systems that employ both digital and analog equipment. One skilled in the art will appreciate that provided herein is a functional description and that the respective functions can be performed by software, hardware, or a combination of software and hardware.

The system 100 can comprise a central location 101 (e.g., a headend), which can receive content (e.g., data, input programming, and the like) from multiple sources. The central location 101 can combine the content from the various sources and can distribute the content to user (e.g., subscriber) locations (e.g., location 119) via distribution system 116. The content may be distributed to user locations 119 based on a custom manifest file that applies trick play operations at trick play automation points (e.g., prepositioned trick play operations) based on one or more profiles associated with content, for example. Each profile of the one or more profiles may include boundary points and/or indications of specific segments corresponding to boundary points. Based on the one or more profiles, the custom manifest file may be created such that the custom manifest file includes trick mode markers and associated trick play operations (corresponding to the trick play automation points) being automatically applied during playback of the content item.

In an aspect, the central location 101 can receive content from a variety of input sources 102a, 102b, 102c. The content can be transmitted from the source to the central location 101 via a variety of transmission paths, including wireless (e.g. satellite paths 103a, 103b) and terrestrial path 104. The central location 101 can also receive content from a direct feed input source 106 via a direct line 105. Other input sources can comprise capture devices such as a video camera 109 or a server 110. The signals provided by the content sources can include a single content item or a multiplex that includes several content items.

The central location 101 can comprise one or a plurality of receivers 111a, 111b, 111c, 111d that are each associated with an input source. For example, MPEG encoders such as encoder 112, are included for encoding local content or a video camera 109 feed. A switch 113 can provide access to server 110, which can be a Pay-Per-View server, a data server, an internet router, a network system, a phone system, and the like. Some signals may require additional processing, such as signal multiplexing, prior to being modulated. Such multiplexing can be performed by multiplexer (mux) 114.

The central location 101 can comprise one or a plurality of modulators 115 for interfacing to the distribution system 116. The modulators can convert the received content into a modulated output signal suitable for transmission over the distribution system 116. The output signals from the modulators can be combined, using equipment such as a combiner 117, for input into the distribution system 116.

A control system 118 can permit a system operator to control and monitor the functions and performance of system 100. The control system 118 can interface, monitor, and/or control a variety of functions, including, but not limited to, the channel lineup for the television system, billing for each user, conditional access for content distributed to users, and the like. The control system 118, or one or more other components of the system 100 such as receiver 111b or server 122, can provide input to the modulators 115 for setting operating parameters, such as system specific MPEG table packet organization or conditional access information. The control system 118 can be located at the central location 101 or at a remote location. The control system 118 may comprise a middleware device for implementing trick play automation. The control system 118 may receive data from a database, such as a user input (e.g., user specified word, machine learning classifier), crowd sourced trick play boundary points, trick play information, metadata, trick play automation points, content profiles, user profiles, custom manifest files and/or the like. The control system 118 may use the received data to create profiles (e.g., content profiles, trick play profiles, etc.) for different types of trick play operations or content preference, such as a violence profile, sexual content profile, vulgar content profile, language content profile, commercial content profile, musical content profile, and/or the like. During playback of content item, the middleware device may process metadata of a created profile corresponding to the content item to perform a trick play operation at trick play boundary points according to the created profile. As an example, a user may select a particular content profile. As an example, a user profile (e.g., that indicates a content preference) may be used to select the particular content profile. For example, a user profile indicating that a user does not like violent content may be used to retrieve a violence profile that may include boundary points used to generate a custom manifest file. The custom manifest file may comprise trick play automation points according to the boundary points and the content preference (e.g., preference not to see violence scenes) indicated by the user profile. As an example, the user may select a content profile such as a commercials profile to select a generated custom manifest file comprising trick play automation points for fast forwarding through portions of commercials.

Trick mode boundary points may be specified by a content profile (e.g., a content profile selected by a user) or determined by the middleware device. As an example, the user may select a content profile (e.g., trick play profile) or the user profile associated with the user may be matched with one or more content profiles. Based on the one or more content profiles, a corresponding custom manifest file may be created. The middleware device may send the custom manifest file to the user playback device based on receiving a request for the content item from the user playback device. For example, one or more created custom manifest files may already be created according to specified content preferences and stored in associated content profiles or user profiles. The middleware device may execute a middleware application to generate a custom manifest file for a user playback device (e.g., user device 124 located at user location 119). For example, depending on the identity of the corresponding user of the user playback device or selected content profile, the middleware device may create a conditioned version of the source manifest file based on the user input (e.g., time markers and trick mode information) provided by the user to the corresponding user playback device. For example, the middleware device may create the conditioned version based on crowd sourced trick mode information, such as a crowd sourced content profile. The middleware device may send an indication of multiple custom manifest file options (e.g., multiple content profiles) to the user playback device based on the crowd sourced trick mode information and/or usage data (e.g., user profile) associated with the user playback device.

The distribution system 116 can distribute signals from the central location 101 to user locations, such as user location 119. The distribution system 116 can be an optical fiber network, a coaxial cable network, a hybrid fiber-coaxial network, a wireless network, a satellite system, a direct broadcast system, or any combination thereof. There can be a multitude of user locations connected to distribution system 116. At a user location 119, a network device, such as a gateway or home communications terminal (HCT) 120 can decode, if needed, the signals for display on a display device, such as on a display 121, such as a television set (TV) or a computer monitor. Those skilled in the art will appreciate that the signal can be decoded in a variety of equipment, including an HCT, a computer, a TV, a monitor, or satellite dish. In an exemplary aspect, the methods and systems disclosed can be located within, or performed on, one or more HCT's 120, displays 121, central locations 101, DVR's, home theater PC's, and the like. The user device 124 at the user location 119 may be used to provide user input for various content output to or displayed by the display 121.

User inputs from multiple user devices (e.g., multiple user devices 124) may be used to determine crowd sourced trick play automation points for generating multiple instances of custom manifest files. The user inputs from the multiple user devices 124 may be compiled into content profiles (e.g., trick play content profiles). For example, the control system 118 may monitor when various user devices 124 apply trick play operations during playback of a content item. The type and timing of the applied trick play operations may be determined and used by the control system 118 to create corresponding content profiles. For example, if the applied trick play operation is an operation to skip through sexual content, boundary points corresponding to the applied trick play operation may be saved in a content profile for the content item and labeled as a no sexual content profile, parental control content profile, and/or the like. This way, other users of other user devices 124 having user profiles similar to the user profile may select (or be automatically matched to) the user profile while viewing the content item. For example, other users may also have user profiles indicating a preference for parental content control. The user may volunteer to contribute the user profile to crowd sourced content profiles such that the other users may select a parental control content profile corresponding to the user profile. The parental control content profile may contain or cause creation of a custom manifest file for skipping through sexual content. The custom manifest file of the parental control content profile may be suggested to the other users such as based on the similarity between the other user profiles and the user profile. As an example, for a content item displayed on the display 121, the user device 124 may receive a machine learning classifier for input into a machine learning algorithm for determining candidate trick play automation points for modifying a manifest file into a custom manifest file.

Crowd sourced content profiles may be created based on crowd sourced trick play boundary points indicated by the user inputs. The crowd sourced trick play boundary points may be used to determine trick play automation points for applying trick play operations according to the crowd sourced trick play boundary points. For example, various viewers may agree to having their manually selected trick play operations included in the creation of crowd sourced content profiles, such as being included in the database. For example, various viewers may save manually selected trick play operations under a content profile name, such as saving sets of trick play fast forward boundary points to fast forward past scenes of a content item with blood or fights for a no violence content profile. Multiple versions of violence related content profiles (e.g., user created violence content profiles, crowd sourced violence content profiles) may be stored in the database. A primary violence trick play profile may be created and stored, such as based on including trick play automation points corresponding to trick play boundary points used by a majority of viewers (or some other threshold quantity of viewers) for violence trick play profiles. A viewer may mark their manually selected/used trick play boundary points for a specific purpose, such as to avoid exposure to violent scenes, so that the marked boundary points may be included in a crowd sourced content profile (or custom manifest file as trick play automation points) corresponding to the specific purpose. The trick play boundary points may correspond to a trick play operation such as a pause operation, fast forward operation, rewind operation, skip operation, reduce volume operation, mute operation, mute closed captions operation, and/or the like.

The viewer may mark the trick play boundary points being used deliberately, such as to contribute to a crowd sourced custom manifest file or for enabling viewing a custom manifest file with the marked boundary points later by friends or family (e.g., for later watching by another member of the viewer's household, such as a child for parental control of content consumption). A user may be presented, via their user device 124, various content profiles and/or custom manifest file options. As an example, a user may select one or more options based on various available content profiles and/or user profile (e.g., similarities between the user profile of the user and other available user profiles or crowd sourced profiles to determine a content profile). For example, the user may select a type of content profile based on user content preferences such as preferences related to violence, commercials, sexual content, and/or the like. As an example, three content profiles may be accessed by the control system 118 and retrieved based on the selected preferences, selected content profiles and/or available user profiles. Any quantity of content profiles may be used, as desired by the user. For example, the user may select a violence content profile for creating a custom manifest file. For example, the user may select two content profiles, such as a combination of a violence content profile and the commercials content profile, for creating a custom manifest file. The user may select a desired custom manifest file from the custom manifest files created according to the user selections.

The user may provide a machine learning classifier via the user device 124. For example, the user may provide a “no blood” machine learning classifier rather than selecting a particular content profile (e.g., violence content profile). The user provided machine learning classifier may be used by a supervised machine learning model to generate machine learning based content profiles or custom manifest files, which may be sent to the user device 124 of the user as selectable options. As an example, the machine learning algorithm may apply the user supplied machine learning classifier to training data (e.g., phrases, closed captioning text, scenes) corresponding to the content item being output at the display 121. In this way, the machine learning classifier may yield a feature set having words or qualities that are predicted to be undesirable to a user operating the user device 124. For example, the feature set may contain swear words, violent language, scenes of the content item having violent visual content, scenes of the content item having nudity, and/or the like. The feature set may be used by the machine learning algorithm to output a suggestion of certain scenes or time portions (e.g., time marker, time code, boundary point) of the content item as candidates for application of a trick mode operation. The suggested scenes or time portions operation may be used by the middleware device to determine the custom manifest file.

As an example, the user may accept the suggestion of the machine learning algorithm so that the middleware device may intercept the content item request from the user playback device and send the custom manifest file having time markers and the associated type of trick play operation suggested by the machine learning algorithm. The type of trick play operation is automatically applied via the custom manifest file during playback of the corresponding content item. This way, the user device 124 executing playback of the content item has user desired trick play operations applied at the specified trick mode markers without any manual selection (e.g., selection of trick play operation at boundary points via user input) being necessary. The user location 119 may not be fixed. For example, a user can receive content from the distribution system 116 on a mobile device such as a laptop computer, PDA, smartphone, GPS, vehicle entertainment system, portable media player, and the like. The HCT 120 can be in communication with one or more user devices 124. The HCT 120 can have logic 123. The logic 123 in the HCT 120 can monitor the content presented on the display 121. The logic 123 in the HCT 120 may detect the one or more user devices 124 present.

The logic 123 in the HCT 120 may create and/or access one or more user profiles corresponding to one or more user devices 124 based on the content presented on the display 121. For example, the one or more user profiles may be used to determine content preferences corresponding to users of the one or more user devices 124. As an example, a user profile may provide insight into what a corresponding user desires or does not desire to see, such as the user profile indicating that the user does not like violent content. For a particular content item, a content profile and/or a custom manifest file having trick play automation points may be determined or selected in accordance with the content preference indicated by the user profile of a particular user device 124 and may be retrieved. As an example, the custom manifest file may be selected from multiple custom manifest files. Each custom manifest file may correspond to a content profile (e.g., violence profile). Each content profile may include a custom manifest file or cause creation of the custom manifest file. The one or more user profiles and/or content profiles can reside on a computing device such as a server 122, which can store or have access to the user profiles and/or content profiles. The content profiles may include crowd sourced trick play information (e.g., crowd sourced trick play boundary points), which may reside on the server 122. For example, crowd sourced content profiles (e.g., trick play profiles) for content preferences such as violent content, commercials, sexual content, vulgar content (e.g., strong or foul language), language content, commercial content, musical content, and/or the like may be stored on the server 122. The logic 123 can use the content displayed on the display 121 to create a user profile or a content profile for the user device 124. The user profile may include information regarding what the user prefers to view, such as movies in the comedy genre. The content profile may be generated for a content item and may include indications of trick play operations manually selected by the user during playback of the content item.

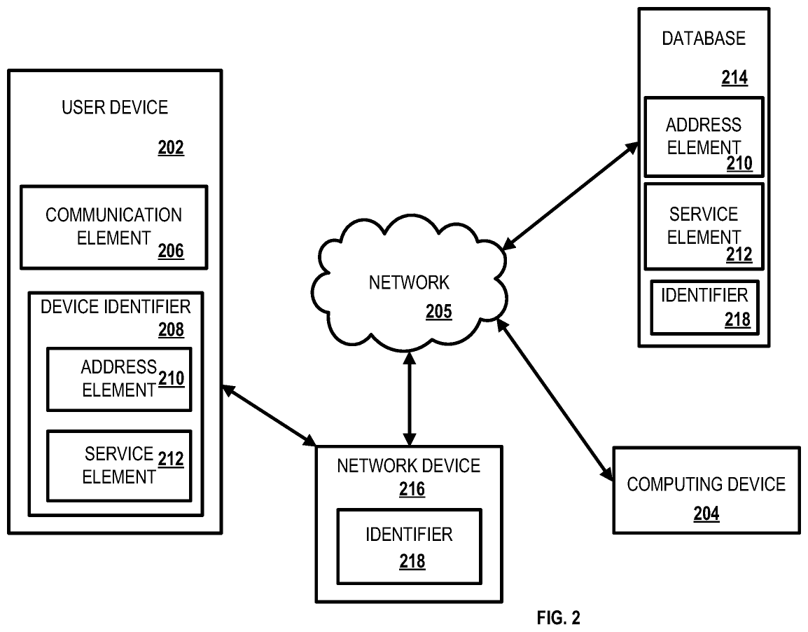

FIG. 2 illustrates various aspects of an example environment in which the present methods and systems can operate. The environment is relevant to systems and methods for trick mode automation applied to content items provided by a content provider. The example environment may include a user device 202 in communication with a computing device 204. The user device 202 may be an electronic device such as a mobile device (e.g., a smartphone, a telephone, a tablet), television, set top box, laptop, computer, a projector, display device, output screen, or other device capable of rendering images, video, content item, video content item, and/or audio. The user device 202 may be a video player capable of playing or rendering multimedia computer files, streaming HTML files, television video content, and/or the like.

The user device 202 may be a device capable of receiving a user input and displaying or outputting a content item such as via rendering the content item for playback on a display of the user device 202. For example, the user device 202 may receive one or more content items on a particular content channel (e.g., television channel), on multiple content channels, as Video on Demand (VOD), or via streaming (e.g., via the Internet). For example, the user device 202 can receive instructions from a user via a user input (e.g., remote, keyboard, keypad, etc.) to switch from one content source to another content source, such as from one television channel to another television channel. The content item may be a video content item such as a movie, sporting event, television series, animated cartoon, and/or the like.

The user device 202 may comprise a communication element 206 for providing an interface to a user to interact with the user device 202 and/or the computing device 204. The communication element 206 may be any communication interface for presenting and/or receiving information to/from the user such as trick mode information, temporal information, and/or machine learning information. For example, the interface may comprise an input/output interface device such as a keyboard, a voice controlled microphone, remote control, a computer mouse, a touchscreen, an application interface, a web browser (e.g., Internet Explorer®, Mozilla Firefox®, Google Chrome®, Safari®, or the like), and/or the like. The user device 202 may be used to select a trick play option, such as a content profile for trick play automation. As an example, for a content item, a user may select one or more content profiles via the user device 202 for applying a trick play operation to the content item according to a content preference indicated by a type of the one or more content profiles, such as sexual content, vulgar content (e.g., strong or foul language), language content, commercial content, musical content, and/or the like. The content preference may be matched to corresponding content profiles having trick play automation points reflecting trick play operations associated with the content preference. A custom manifest file may be created for each content profile selected by the user and/or a single custom manifest file may be created according to all selected content profiles. A content profile may be matched to a user profile corresponding to the user device 202. The user may indicate agreement with the matched content profile, such as approving application of a suggested content profile for the content item via the user device 202 during playback of the content item.

The content profile may include a trick play boundary point determined according to user activity. For example, the user may use a remote control to indicate trick play boundary points while viewing content, such as to use the indicated trick play boundary points for a future viewing session. For example, a trick play operation applied by the user the first time the user viewed a particular content item according to an original manifest file may be used to determine the indicated trick play boundary points As an example, the trick play boundary points indicated during the first viewing of a content item may be used to create a custom manifest file that applies, during a second or subsequent viewing of the content item, the same trick play operations at trick play automation points corresponding to the trick play boundary points. This way, trick play operations are automatically applied consistently with the trick play markers applied by the user the first time. As an example, the trick play boundary points indicated by the user may be used as a contribution to a crowd sourced trick play boundary point database (e.g., database 214), such as for creation of a crowd sourced content profile. The trick play boundary points may be used to determine the corresponding trick play automation points and associated trick play operations for creating custom manifest files corresponding to the trick play boundary points.

The trick play boundary points may be determined based on textual input from the user. For example, the textual input may indicate a word that the user does not like or does not desire to hear during content playback. For example, the textual input may be used as a filter to determine portions of the content item for application, via the custom manifest file, of trick play automation points corresponding to the determined trick play boundary points. For example, the textual input may be a word, phrase, textual string, and/or the like. The user provided textual input may be categorized under a content profile. For example, for a user interface of the user device 202, at least one user specified word may be a configurable setting (e.g., of a plurality of configurable settings) that the user may select. For example, the user may select that the user specified word should be used to determine a set of trick play boundary points. As an example, the user inputs may include closed captioning text, such as swear words, that the user does not want to hear. For example, for parental content control, the user input closed captioning text may be used to create a custom manifest file having sets of time markers for fast forwarding through scenes in which a character utters a swear word. For example, a user may input at least one word via the user device 202, such as a particular swear word. The user provided word may correspond to closed caption information of at least one scene of the content item. As an example, the user may specify or define a type of trick play operation in conjunction with the at least one word (e.g., the type of trick play operation to take for portions of the content item corresponding to the at least one word) such as a fast forward operation.

For example, a first instance that the user specified word appears may be used to determine a start boundary point (e.g., time marker) of the set of trick play boundary points and a subsequent instance that the word appears may be used to determine as an end boundary point (e.g., an endpoint time mode marker that indicates the end of a boundary period for a trick play operation). For example, the start of the word may be used to determine the start boundary point while the end of the word is used to determine the end boundary point so that a trick play operation may be applied to a portion of content occurring between the start boundary point and end boundary point. As an example, if the user specified word is a swear word treated as an end time marker or a start time marker, a fast forward or rewind trick play operation may be automatically implemented when the swear word is uttered during content playback. This may enable the user to bypass or flag when swear words occur during content playback. Also, the user may select that the specified word should cause the end boundary point to be set at a time after the word occurs. As an example, the word may be a curse word that causes an end boundary point to be placed a predetermined time after each instance that the curse word appears in the content item, such as 30 seconds after the curse word appears. This may enable an entire undesirable scene to be bypassed, even if portions of the undesirable scene do not include curse words being uttered.

The trick play boundary points may be determined from data analysis or machine learning based on user data, user inputs, crowd sourced data and/or other records. For example, the user may provide a machine learning classifier (e.g., a classifier to classify closed captioning text into text corresponding to a trick play operation or not corresponding to a trick play operation) via the user device 202. As an example, the user specified machine learning classifier may indicate a content preference used to determine trick play boundary points, such as a “no violence” machine learning classifier. This machine learning classifier may be used to create a custom manifest file having sets of time markers for skipping fight scenes such as scenes involving guns or a person bleeding, for example. For example, the machine learning classifier may be used to generate custom manifest files having trick play automation points corresponding to the determined trick play boundary points. As an example, a shared trick mode machine learning classifier may be used as feedback for a supervised machine learning model. The machine learning classifier may comprise or involve linear classifiers, support vector machines, decision trees, neural networks, quadratic classifiers, kernel estimation, and/or the like. For example, for a particular content item and via the interface, the user may specify text, words, and/or closed captioning information. In this way, the user may use the communication element 206 and/or the user device to indicate content profiles, previously selected trick mode operations, and/or the like that may be used to update or modify a source manifest file corresponding to the particular video item. A feature set may be generated based on a the machine learning classifier (e.g., curse words). As an example, the feature set may be generated based on multiple machine classifiers, in which each classifier is provided by a user of the plurality of users of the one or more user devices 124. The classifiers may be shared and used as input into a machine learning algorithm to output the feature set.

A machine learning based content profile and/or custom manifest file may be determined based on a supervised machine learning model that generates suggested trick play automation points based on multiple input classifiers provided by multiple users. As an example, for three users: user A may provide their input classifier as specifying no blood, no deaths, and no ghosts; user B may provide their input classifier as specifying no fights; and user C may provider their input classifier as specifying no violence. The input classifier may be used as a filter or criteria to determine a start point for a set of trick play boundary points. For example, if a fight scene is detected in a content item, the start of the fight scene may be used as a start boundary point for applying a fast forward trick play operation for user B. As an example, the custom manifest file for user B may include a start trick play automation point corresponding to the time point determined to be when the fight scene starts (e.g., the machine learning model may use a punch being thrown as an indicator that the fight scene has started). For example, the end of the fight scene may be determined (e.g., the scene changes and no longer includes any fight combatants) and used an end trick play automation point, such that playback of the content item changes to play after fast forwarding to the end trick play automation point. Based on user A's input classifiers, the machine learning algorithm may suggest to skip scenes with death in the movie “The Lion King” and fast forward past scenes with blood in the movie “Inglourious Basterds.” Based on user B's input classifiers, the machine learning algorithm may suggest skipping scenes with fights in the movie “The Mummy.” If user A and user B are friends of user C, the supervised machine learning model executing the machine learning algorithm may then predict trick play operations for user C based on user A and user B's input classifiers. As an example, the supervised machine learning model may predict that user C will not like bloody fight scenes in the movie “The Scorpion King” based on user C's friendship with user A and user B and the respective input classifiers. Based on a classification based algorithm (e.g., using labels) or a regression based algorithm (e.g., without using labels), the supervised machine learning model may recommend to skip scenes of “The Scorpion King” that are classified by the machine learning algorithm applying classifiers of no blood and no fights.

The trick play boundary points may be determined from crowd sourced data. For example, crowd sourced data from other viewers, such as from user devices other than the user device 202 (e.g., users of the one or more user devices 124), may be used to determine trick play boundary points for creation of crowd sourced content profiles. As an example, the crowd sourced content profiles may be determined based on crowd sourced data from multiple user devices. For example, each user of one of the multiple user devices may share data or information associated with trick mode, such as manually applied trick mode operations, selected trick mode operations, and/or trick mode machine learning classifiers. For example, each user may agree to send information to the computing device 204 (e.g., via the network 205) indicative of a start and stop point of a trick play operation that the respective user manually selected while viewing a particular content item according to an original manifest file. The information may be used to determine trick play boundary points included in a crowd sourced content profile. The crowd sourced content profile may be determined based on the shared information of a quantity of users or viewers, such as a threshold quantity of users. The shared information may indicate the behavior of corresponding users, such as a trick play operation manually selected by a corresponding user. For example, if a majority of viewers or users select a fast forward or rewind trick play operation at particular points of a content item, the particular points of the content item may be selected as trick play boundary points for the crowd sourced content profile.

The trick play boundary points, whether determined based on user data, user inputs, crowd sourced data, machine learning, and/or other data, may be used to determine trick play automation points corresponding to the trick play boundary points. The corresponding trick play automation points may be included in a custom manifest file for application of a trick play operation according to the trick play boundary points. The trick play boundary points may be correlated to specific segments in a source manifest file. For example, the trick play boundary points may be used to determine specific segments in a source manifest file corresponding to the trick play boundary points. For example, a clock time and segment duration may be used to determine specific segments in a source manifest file corresponding to the trick play boundary points. The determined specific segments may be used to determine trick play automation points (corresponding to the trick play boundary points) for inclusion in a custom manifest file. For example, the determined specific segments may be used to generate the custom manifest file. The custom manifest file may be included in a content profile or the custom manifest file may be generated based on selection of the content profile by the user. For example, a crowd sourced custom manifest file may be included in or caused to be created by a crowd sourced content profile containing crowd sourced trick play boundary points.

Custom manifest files associated with crowd sourced content profiles may have trick play automation points corresponding to crowd sourced trick play boundary points specified by the crowd sourced content profiles. For example, a subset of the one or more user devices 124 that tend to fast forward through violent scenes when a content item is being output may be used to create a crowd sourced “no violence” custom manifest file and/or content profile based on what and when fast forward operations are respectively applied during output of the content item by the subset. The crowd sourced “no violence” custom manifest file may have trick play automation points corresponding to the applied fast forward time markers. A quantity of users selecting the fast forward operations or other trick play operations (e.g., rewind) at a particular set of trick play boundary points may be compared to a threshold to determine whether the particular set of trick play boundary points should be used to determine crowd sourced trick play automation points. For example, if the quantity of users (e.g., a majority of users) exceeds the threshold, then trick play boundary points corresponding to the quantity of users may be used to determine trick play automation points associated with a content profile comprising the trick play boundary points.

A crowd sourced content profile may include or trigger generation of a custom manifest file based on the determined trick play automation points. As an example, if a majority of users having user profiles that specify a preference for no sexual content fast forward past a portion of the content item with sexual content, a crowd sourced “no sexual content” content profile and/or associated “no sexual content” custom manifest file may be created. For example, the crowd sourced “no sexual content” content profile may contain or cause creation of the “no sexual content” custom manifest file containing trick play automation points corresponding to fast forward trick play boundary points used by the majority of users. The “no sexual content” custom manifest file may be created based on an original manifest file for the content item. For the crowd sourced “no sexual content” content profile, the computing device 204 may determine specific segments and/or the time points of the original manifest file corresponding to the forward trick play boundary points to create the “no sexual content” custom manifest file, such as based on clock time and/or segment duration. As an example, if a threshold quantity of users manually selected a rewind operation at a particular start and stop point (e.g., start trick play boundary point of 10 minutes into playback of the content item and stop trick play boundary point of 15 minutes into the playback), a type of crowd sourced content profile may be created by the computing device 204 based on the trick play boundary points of 10 minutes and 15 minutes. The creation of the type of crowd sourced content profile may cause the computing device 204 to create or prepare to create a type of custom manifest file for the type of crowd sourced content profile.

The creation of the type of crowd sourced content profile may cause the computing device 204 to determine the corresponding specific segments. The specific segments may be used to determine trick play automation points corresponding to the trick play boundary points of 10 minutes and 15 minutes. The determined specific segments of the manifest file may be used to create the type of crowd sourced custom manifest file. This way, the computing device 204 may include the determined trick play automation points in the type of crowd sourced custom manifest file and/or the associated type of crowd sourced content profile or create the crowd sourced custom manifest file based on the type of crowd sourced content profile. The threshold quantity of users may be determined based on the machine learning algorithm. For example, the machine learning algorithm may determine how many users should manually select a trick play operation at particular points before those particular points are used as trick play boundary points for generating a crowd sourced content profile. As an example, the threshold for the quantity of users may be determined according to a configuration setting (e.g., user configuration setting).

One or more content profiles may be suggested or recommended to a user for a particular item of content. For example, an indication of options of content profiles (e.g., crowd sourced content profiles) may be sent to the user device 202. The user profile corresponding to the user device 202 may be retrieved so that the options of content profiles may be determined. As such, during playback of content on the user device 202, that content is played back with trick play automation points desired by the user of the user device 202 via selection or suggestion of a corresponding content profile and/or custom manifest file. For example, a suggested or user selected crowd sourced content profile or user provided content profile may be used to determine which custom manifest file of a plurality of custom manifest files should be sent to the user device 202. The plurality of custom manifest files may be stored in memory (e.g., the database 214) and tagged under corresponding content profiles. Also, a custom manifest file may be generated after a profile (e.g., user profile, content profile) is selected or retrieved. As an example, the user profile may be indicate a user preference for determining a content profile, such as based on the user preference specifying content without violence, content without swear words, re-watching content with musical content, and/or the like.

The user profile may be used to determine a plurality of custom manifest file options or content profile options to be presented to the user device 202. For example, based on the user preference, a musical content profile containing or causing creation of a musical content custom manifest file may be suggested. This may cause the user device 202 to apply trick play operations during output of the content item corresponding to the musical content profile. For example, the user device 202 may rewind through musical content according to crowd sourced trick play boundary points specified by the suggested musical content profile. For example, the user profile may comprise usage data that indicates what content has historically been output and been subject to a trick play operation on the user device 202. This usage data may be used to determine custom manifest file options that are consistent with the historical usage of the user device 202. For example, the usage data may indicate that the user of the user device 202 has previously selected a skip trick play operation when one or more of violent content, sexual content, vulgar content (e.g., strong or foul language), language content, commercial content, musical content, and/or the like is output on the user device 202. The historical usage data may be used to determine which crowd sourced content profiles and/or custom manifest files should be offered to the user as options. For example, a subset of crowd sourced content profiles and/or crowd sourced custom manifest files may be offered to a particular user based on the usage data of the particular user. As an example, a crowd sourced “no violence” content profile for a particular content may be determined to be an option for selection by the user of the user device 202 when the user has historically skipped violent scenes of content items output on the user device 202.

The user profile may indicate other information, such as other devices (e.g., subset of the one or more user devices 124) that are considered friends and/or family relative to the user device 202. For example, other user devices 124 located in the same home as the user device 202 and/or sharing the same account information may be considered devices used by family members. For example, the user profile may be used to determine crowd sourced custom manifest file options based on information in the user profile indicative of friends and/or family, such as user provided information in a social media section of the user profile. The content profile options and/or custom manifest files presented to or selected by the friends and/or family may be used to suggest the same or similar content profile options and/or custom manifest files to the user via the user device 202. For example, a crowd sourced “no violence” content profile may be determined as an option because the user profile indicates that users associated (e.g., friends, family, other users in the same demographic range, etc.) with the user device 202 also viewed content according to the crowd sourced “no violence” content profile or manually fast forwarded through violent scenes. The type of content profile options may be categorized according to the type of trick play boundary points used to create the respective content profiles. For example, the content profiles may be categorized based on trick play boundary points used for violent content, sexual content, vulgar content (e.g., strong or foul language), language content, commercial content, musical content, and/or the like. The categories of content profile options used by friends and family of the user may be used to determine content profile options presented to the users. For example, if friends of a user typically select a musical content profile for a category of musical content (e.g., rewinding to re-watch certain musical scenes), it may be assumed the user may also desire to select the same type of musical content profile such that this type of musical content profile is an option offered to the user device 202.

The user may use the user device 202 to select from the offered options of content profiles and/or custom manifest files. The user may indicate, via the user device 202, a particular type of content profile for a content item being output on the user device 202. The indicated content profile may be from the offered options or from another type of content profile otherwise available to the user. The user may select the particular type of content profile so that during playback of the content item, trick play operations may be automatically applied according to trick play automation points corresponding to the particular type of content profile. For example, the user may select a “no violence” content profile so that the user device 202 automatically fast forwards, or otherwise skips, through violent content during playback of the content item. The automatic fast forward may be applied according to trick play automation points according to trick play boundary points determined based on crowd data or user data. As an example, the trick play boundary points used to create the selected “no violence” content profile may be based on crowd selected fast forward trick play operations such as when and how friends and family (who also do not desire to view violent content) of the user selected trick play operations when they watched the same content item. As an example, the trick play boundary points used to create the selected “no violence” content profile may be based on user selected fast forward trick play operations previously selected by the user in a previous content viewing session, such as for parental control of content when the user device 202 is used by a child of the user to view the content item.

The communication element 206 may enable the user device to communicate with the computing device 204, database 214, and/or network device 216 via a network 205. For example, the communication element 206 may communicate via a wired network protocol (e.g., Ethernet, LAN, WAN, etc.) on a wired network (e.g., the network 205). The communication element 206 may include a wireless transceiver configured to send and receive wireless communications via a wireless network (e.g., the network 205). The wireless network 205 may be a Wi-Fi network. The network 205 may support communication between the computing device 204, database 214, and/or network device 216 via a short-range communications (e.g., BLUETOOTH®, near-field communication, infrared, Wi-Fi, etc.) and/or via a long-range communications (e.g., Internet, cellular, satellite, and the like). For example, the network 205 may utilize Internet Protocol Version 4 (IPv4) and/or Internet Protocol Version 6 (IPv6). The network 205 may be a telecommunications network, such as a mobile, landline, and/or Voice over Internet Protocol (VoIP) provider.

The communication element 206 of the user device 202 may be configured to communicate via one or more of second generation (2G), third generation (3G), fourth generation (4G), fifth generation (5G), GPRS, EDGE, D2D, M2M, long term evolution (LTE), long term evolution advanced (LTE-A), code division multiple access (CDMA), wideband code division multiple access (WCDMA), universal mobile telecommunications system (UMTS), wireless broadband (WiBro), Voice Over IP (VoIP), and global system for mobile communication (GSM). The communication element 206 of the user device 202 may further be configured for communication over a local area network connection through network access points using technologies such as IEEE 802.11. The user device 202 the computing device 204, and/or the database 214 may be in communication via a private and/or public network 105 such as the Internet or a local area network. Other forms of communications may be used such as wired and wireless telecommunication channels. Other software, hardware, and/or interfaces may be used to provide communication between the user/user device 202, the computing device 204, and/or the database 214.

The communication element 206 may request or query various files from a local source and/or a remote source. The communication element 206 may send data to a local or remote device such as the computing device 204. For example, the user device may send, to the database 214, metadata comprising trick mode information such as time markers or time codes associated with a trick play operation for the particular content item. The metadata may be requested by the computing device 204 via a query. For example, the user device may send, to the computing device 204, a request for the particular content item. For example, the user device may receive, from the computing device 204, the custom manifest file based on the user defined trick mode information for trick mode automation when the particular content item is rendered by the user device 202. The user defined trick mode information may be stored locally within a corresponding user profile as metadata stored in memory (not shown) of the user device 202. The user defined trick mode information may be stored remotely within the corresponding user profile as metadata stored in a remote data repository (e.g., the database 214). The user may indicate, via the communication element 206, to the user device 202, whether the user defined trick mode information should be applied to the particular content item as trick play operations for trick play automation. For example, the user may indicate agreement with trick play operations at particular boundary points, as suggested by the machine learning algorithm. The specific user defined trick mode information or trick play machine learning algorithm inputs may be categorized by user profile so that a conditioned version of a source manifest file corresponding to a specific content item may be dynamically generated depending on which specific user, user profile, and/or user device 202 is requesting the specific content item. As an example, the conditioned version of the source manifest file for a particular user may depend on the machine learning classifiers or inputs (e.g., trick mode information, closed captioning text string) provided by the particular user.

The user device 202 may be associated with a device identifier 208. The device identifier 208 may be any identifier, token, character, string, or the like, for differentiating one user device (e.g., user device 202) from another user device. The device identifier 208 may identify an user device as belonging to a particular class of user devices. The device identifier 208 may be information relating to an user device 202 such as a manufacturer, a model or type of device, a service provider associated with the user device 202, a state of the user device 202, a locator, and/or a label or classifier. Other information may be represented by the device identifier 208. The device identifier 208 may be or comprise an address element 210 and a service element 212. The address element 210 may be or provide an internet protocol address, a network address, a media access control (MAC) address, an Internet address, and/or the like. The address element 210 may be relied upon to establish a communication session between the user device 202, the computing device 204, the database 214, and/or other devices and/or networks. The address element 110 may be used as an identifier or locator of the user device 202. The address element 110 may be persistent for a particular network.

The service element 212 may be an identification of a service provider associated with the user device 202 and/or with the class of user device 202. The class of the user device 202 may be related to a type of device, capability of device, type of service being provided, and/or a level of service (e.g., business class, service tier, service package, etc.). The service element 212 may be information relating to or provided by a communication service provider (e.g., Internet service provider) that is providing or enabling data flow such as communication services to the user device 202. The service element 212 may be information relating to a preferred service provider for one or more particular services relating to the user device 202. The address element 210 may be used to identify or retrieve data from the service element 212, or vice versa. At least one of the address element 210 and the service element 212 may be stored remotely from the user device 202 and retrieved by one or more devices such as the user device 202 and the computing device 204. Other information may be represented by the service element 212.

The computing device 204 may be disposed locally or remotely relative to the user device 202. The computing device 204 may be part of a content delivery network (CDN) of a content provider that provides content items. The computing device 204 may be a server for communicating with the user device 202. The computing device 204 may communicate with the user device 202 for providing data and/or services. The computing device 204 may allow the user device 202 to interact with remote resources such as data, devices, and files. The computing device 204 may receive metadata comprising trick mode information such as time markers or time codes associated with a trick play operation for the particular content item. The metadata may include a duration of the trick play operation. For example, the computing device 204 may receive the metadata from the database 214 based on sending a query to the database 214. Based on the metadata, the computing device 204 may determine the custom manifest file for trick play automation according to defined trick mode information of the metadata. As described herein, the defined trick mode information may be user defined, crowd source defined, machine learning algorithm defined, and/or the like.

As an example, the computing device 204 may determine a segment duration (e.g., fragment duration) as well as a starting trick play automation point (e.g., starting time code) and an ending trick play automation point (e.g., ending timecode) of the custom manifest file corresponding to the duration of the trick play operation. The computing device 204 may determine a number of segments or fragments spanning the duration of the trick play operation. The computing device 204 may determine the identity of the segments or fragments and fast forward through the segments or fragments if the metadata defined trick play operation is fast forward, for example. In this way, the custom manifest file may cause the user device 202 to automatically perform the metadata defined trick play operation at the determined automation points during playback of the particular content item. The computing device 204 may send the custom manifest file to the user device 202 upon the user device 202 making a request for the particular content item. The computing device 204 may manage the communication between the user device 202 and the database 214 for sending and receiving data therebetween. The data may be trick mode information, for example.

The database 214 may store a plurality of files or data that comprises or is associated with the trick mode information or machine learning information related to the trick mode information. The user device 202 and/or the computing device 204 may request, store, and/or retrieve a file or data from the database 214. The database 114 may store information relating to the user device 202 and/or the computing device 204 such as the address element 110 and/or the service element 112. The computing device 204 may obtain the device identifier 208 from the user device 202 and retrieve information from the database 214 such as the address element 210 and/or the service element 212. As an example, the database 114 may store an identifier 218 of the network device 216. The user device 202 and/or the computing device 204 may obtain the identifier 218 of the network device 216 from the database 114. Any information may be stored in and retrieved from the database 214, such as trick play information and/or machine learning classifiers for implementing trick play operations at corresponding timecodes. The database 114 may be disposed remotely from the computing device 204 and accessed via direct or indirect connection. The database 214 may be integrated with the computing device 204 or some other device or system.

A network device 216 may be in communication with a network such as network 205. One or more of the network devices 216 may facilitate the connection of a device or component, such as user device 202, the computing device 204, and/or the database 214 to the network 105. The network device 216 may be configured as a wireless access point (WAP). The network device 216 may be configured to allow one or more wireless devices to connect to a wired and/or wireless network using Wi-Fi, BLUETOOTH®, or any desired method or standard. The network device 216 may be configured as a local area network (LAN). The network device 216 may be a dual band wireless access point.

The network device 216 may be configured with a first service set identifier (SSID) (e.g., associated with a user network or private network) to function as a local network for a particular user or users. The network device 216 may be configured with a second service set identifier (SSID) (e.g., associated with a public/community network or a hidden network) to function as a secondary network or redundant network for connected communication devices. The network device 216 may have an identifier 218. The identifier 218 may be or relate to an Internet Protocol (IP) Address IPV4/IPV6 or a media access control address (MAC address) or the like. The identifier 218 may be a unique identifier for facilitating communications on the physical network segment. There may be one or more network devices 216. Each of the network devices 216 may have a distinct identifier 218. An identifier (e.g., the identifier 218) may be associated with a physical location of the network device 216.

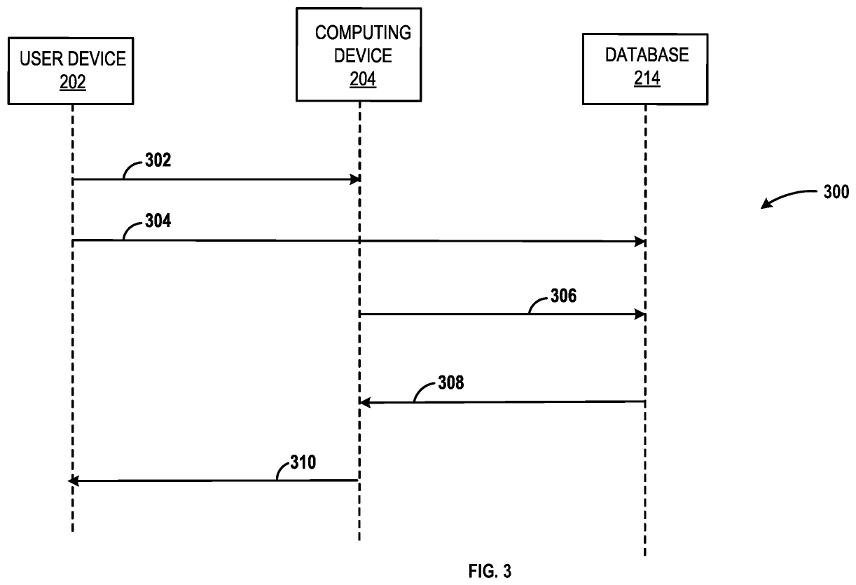

FIG. 3 shows an example set of processing flows 200 of the system 300. At processing flow 302, the user device 202 may request a content item such as a video content item, that can be delivered as an adaptive bit rate (ABR) video asset, for example, or any other type of video transmission. The request for the content item may be sent to the computing device 204. The request for the content item may comprise a request for a source manifest file or a custom manifest file corresponding to the content item. The request for the content item may include trick mode information specified by a user of the user device 202. For example, the user may specify trick mode actions to be taken at certain points of the video content, such as via a remote control. The trick play actions may be automatically applied during playback of the content item so that the user advantageously does not have to adjust their attention from viewing the video content to manually selecting and/or setting trick mode actions. For example, the user may select a custom manifest file with trick play automation points corresponding to trick play boundary points of manually selected trick mode actions. For example, the user may be a parent indicating trick mode information for parental control of content viewed by their child. As an example, the user may select a corresponding content profile so that a trick play operation (e.g., skip operation) may be automatically performed to skip through violent content when their child is viewing content. As an example, the indication of the trick play operation may be saved for a particular content item so that when the particular content item is viewed again, the user device 202 may provide an option to automatically perform the indicated trick play operation. As an example, the user device 202 may provide an option to the user to agree to suggested trick mode markup points and associated trick mode operations, such as based on the suggestion of a machine learning algorithm.

The user may indicate, via a user interface of the user device 202 (e.g., the communication element 206) a trick play operation to be taken at the first timecode until the second timecode. The trick play operation may be a pause operation, fast forward operation, rewind operation, skip operation, reduce volume operation, mute operation, mute closed captions operation, and/or the like. The user device 202 may determine a duration of the trick play operation based on the trick play boundary points. For example, the user may indicate, via the user interface, a machine learning classifier and/or a word (e.g., word that may appear in closed captioning text of the content item). The user device 202 and/or the computing device 204 may determine scenes of the content item that correspond to the machine learning classifier and/or the word. The user device 202 and/or the computing device 204 may further determine at least one trick play operation to be performed during the scenes, such as based on trick play boundary points associated with the scenes. For example, for the particular content item, multiple users may indicate, via respective user devices 202, previously selected trick play operations, indications of trick play operations to be taken, durations of trick play operations, machine learning classifiers, content preferences, textual input, closed captioning words, and/or the like. The machine learning classifiers and/or closed captioning words may be used to dynamically trigger trick play operations. For example, the machine learning classifiers and/or closed captioning words may be used as part of a machine learning algorithm and/or supervised machine learning model. For example, the machine learning classifiers and/or closed captioning words may be used to identify matching scenes of the particular content item that a trick play operation should be applied to. As an example, the user may specify a skip, reduce volume, and/or some other trick play operation to be applied for the scenes matching the user specified closed captioning words.

In this way, the user may specify to skip, reduce volume, etc. through matching scenes containing undesirable content such as kissing, blood, and/or fighting. As an example, the machine learning classifiers may be used to suggest, to the user, scenes in which an associated trick play operation should be performed. The trick mode information from the multiple users may be crowd sourced trick mode information that can be used to suggest trick play operations to be taken at certain portions of the particular content item. For example, the user may be informed by their user device 202 that a crowd sourced trick play boundary point may start at 30 minutes into a movie and span to another crowd sourced trick play boundary point at 33 minutes into the movie so that an associated trick play operation (e.g., fast forward) may be automatically performed based on the crowd sourced trick mode information. The user may indicate, via the user interface, whether the user agrees (or disagrees) that the crowd sourced trick mode information should be applied to the particular content item for automatic performance of trick play according to the crowd sourced trick mode information. The user indicated trick mode information and/or crowd sourced trick mode information may be stored locally or remotely in a memory component, for example. As an example, the user indicated trick mode information and/or crowd sourced trick mode information may be stored as metadata in the database 214.

For each user, the respective user defined trick play timecode, trick play duration, type of trick play operation, word, machine learning classifier, and/or the like may be stored and tagged in the database 214 under a respective user profile. The user profile may be associated with device identifier 208 of the user device 202. The stored metadata may be used for combination with the original source manifest (e.g., ABR manifest) for trick play automation. As an example, when the user selects a specific content item for playback by the user device 202, the user device 202 may retrieve the user specific and/or crowd sourced trick mode information (e.g., trick play boundary points) to give the user an option to automatically apply trick play actions to the specific content item during viewing. The user may indicate, via the user interface, whether the trick play actions should be applied. The request for the content item from the user device 202 may comprise a request for a uniform resource location (URL) for the original source manifest. The computing device 204 may intercept the request for the source manifest URL and return a conditioned version of the source manifest to the user device 202 based on the computing device 204 retrieving data from a conditional data network (e.g., comprising the database 214), such as returning the custom manifest file. The computing device 204 may obtain the source manifest file via the original source manifest URL, for example.

At processing flow 304, the user device 202 (or multiple user devices 202 for crowd source trick play) may send an indication of a trick play operation to the database 214. The indication of the trick play operation may comprise trick play information such as previously selected trick play operations, indications of trick play operations to be taken, durations of trick play operations, machine learning classifiers, closed captioning words, and/or the like. As an example, the user device 202 may send “start” and “stop” points of a previously user selected trick play operation. For example, the “start” and “stop” points may be used to determine trick play automation points. The trick play boundary points may be sent to the database 214 as metadata while the user is watching the content item according to the original source manifest file. For example, the user device 202 may render the content item for playback according to the source manifest file. While the user is watching the content item according to the original source manifest, the user may indicate, via the user interface of the user device 202, one or more trick play operations corresponding to one or more timecodes. For example, a first set of timecodes may start at 6687.5034 and stop at 12920.557823 and a second set of timecodes may start at 26899.503 and stop at 29000.557.

The user may also indicate, via the user interface of the user device 202, an associated trick play operation corresponding to a set of time codes. For example, the first set of timecodes and/or the second set of timecodes may correspond to at least one of: a skip, fast forward, and/or mute trick play operation. For example, the user may indicate, via the user interface of the user device 202, a duration of the trick play operation. As an example, the trick play boundary points sent to the database 214 may be crowd sourced from previous trick play operations selected by multiple user devices 202. As an example, trick play boundary points and/or other trick play information sent to the database 214 may be determined based on a user supplied closed captioning word, machine learning classifier, and/or machine learning algorithm. The trick play boundary points and/or other trick play information may be conditioned metadata stored by the database 214 for updating or modifying the source manifest. The stored trick play boundary points and/or other trick play information may be tagged and/or organized by the database 214 according to a respective content profile or a crowd sourced tag. The source manifest may be stored in a suitable memory device. The source manifest may be an ABR manifest, for example, that does not comprise specific time points for providing a segment of the content item. Accordingly, a time offset may be calculated relative to the ABR manifest to determine the time point of the ABR manifest that correspond to the user defined or crowd defined trick play boundary points for creation of a custom manifest file.

At processing flow 306, the computing device 204 may send a query to the database 214. The query may be a request for the conditioned metadata stored by the database 214. The computing device 204 may execute the processor executable instructions of a middleware application which causes the computing device 204 to send the query and determine a conditioned version of the source manifest for the content item (e.g., custom manifest file). The database 214 may determine whether any stored conditioned metadata exists for or corresponds to the requested source manifest and/or content item. At processing flow 308, if stored conditioned metadata is present, the database 214 may send the requested conditioned metadata to the computing device 204. If the stored conditioned metadata is not present, the database 214 may return a response to the computing device 204 indicating null (e.g., indicating that the requested conditioned metadata has not been found or does not exist). The computing device 204 may also send any requests for and receive any information to facilitate determining the conditioned version of the source manifest for the content item.

For example, the computing device 204 may request machine learning classifiers, feature sets, or other machine learning algorithm inputs. As an example, the computing device 204 may receive classifiers from multiple family members (e.g., via their respective user devices 202) in a residence. The computing device 204 may use the classifiers in a machine learning algorithm to classify training data in order to determine a feature set of words that are undesirable and an associated trick play action to be applied. The determined feature set of words may be suggested phrases or words and the associated trick play actions to be applied. For example, the determined words may have an undesirable character or be closed caption text corresponding to scenes in the content item for which a trick play operation should be applied. For example, the scenes may correspond to violence, nudity, or some other undesirable quality. The suggested phrases or words of the feature set may be used to determine the boundary points of various trick play operations and the types of the trick play operations. The machine learning algorithm may be used to output trick play boundary points for application of specific trick play operations that are associated with the classifiers. As an example, the computing device 204 may execute a supervised machine learning model to determine the type of trick play operation to be applied to the scenes of the content item and/or the time point at which the trick play operation is to be applied.

The training data may comprise words and scenes of various content items. As discussed above, application of the machine learning algorithm to the training data may yield a feature set. The feature set may be categorized such as based on characteristics of content items (e.g., Motion Picture Association Ratings). For example, the categories of feature sets may include: the type or rating of movie (e.g., R, PG-13, audience approval rating), descriptive tags (adventure, violent, sexual, smoking etc.), closed caption (e.g., closed captioning text), movie audio, video artifacts (e.g., light, dark scenes), and/or the like. The size of both the training data and the feature set may be determined, filtered, or otherwise influenced by user inputs (e.g., input words, input closed captioning text) such that the training data and the feature set are not oversized or undersized. An oversized or large feature set may produce an over fitting machine learning output while an undersized or small feature set may produce an under fitting machine learning output. The computing device 204 may determine the trick play boundary points based on the metadata, machine learning information, or other trick play information received from the database 214. Based on the determined trick play boundary points, the computing device may determine a custom manifest file that is a conditioned version of the ABR source manifest file with trick play automation points.

At processing flow 310, the computing device 204 may send the determined custom manifest file to the user device 202. The determined custom manifest file may be a dynamically modified manifest file based on user defined, crowd sourced, or machine learning algorithm determined trick play boundary points, for example. The determined custom manifest file may be sent to the user device 202 as a conditioned version of the source manifest requested by the user device 202. The user device 202 may use the determined custom manifest file to play the content item with execution of trick play automation points contained in the custom manifest file. The computing device 204 may execute the middleware application to determine specific segments in the source manifest file corresponding to the trick play boundary points. The middleware application may determine the specific segments based on a clock time, such as a clock time related to the trick play boundary points. For example, the middleware application may determine time offsets or specific segments of the ABR source manifest that corresponds to the sets of trick play boundary points indicated by the metadata received from the database 214. For example, the time offsets may be compared to a content segment duration in conjunction with the clock time to determine timecodes of one or more segments associated with the boundary points. The determined timecodes, time offsets, and/or specific segments may be used to generate the custom manifest file. As an example, trick play automation points of the custom manifest file may be determined based on the timecodes of the one or more segments. The computing device 204 may determine the content segment duration (e.g., fragment duration) associated with each segment of a plurality of segments of the content item. For example, the computing device 204 may calculate a fragment duration of two seconds for each fragment of a movie content item lasting 80 minutes (4900000 milliseconds). The duration of the movie content item may be determined or received from the source manifest. The computing device 204 may exclude any non-entertainment content from the source manifest, for example, which normalizes the source manifest.

Because the ABR content item (e.g., normalized ABR movie content item) may not comprise specific time points, the computing device 204 may not be able to provide a specific chunk of the content item that corresponds to the sets of trick play boundary points indicated by the metadata received from the database 214. Instead, the computing device 204 may calculate a time offset from the beginning of the ABR content item to dynamically determine sets of trick play automation points (e.g., a starting trick play automation point and an ending trick play automation point corresponding to the indicated boundary points) of the trick play operation indicated by the metadata. The computing device 204 may dynamically determine a quantity, number, and/or identity of fragments or segments that correspond to sets of trick play time markers indicated by the metadata. As an example, the computing device 204 may determine, based on the calculated fragment duration of 2 seconds and a duration of the trick play operation indicated by the metadata, a segment of the plurality of segments associated with the duration of the trick play operation. As an example, the determined segment may be a content segment that corresponds to a boundary period of the trick play operation indicated by the metadata (e.g., a marker of the sets of trick play time markers indicated by the metadata). For example, the determined segment may be the starting content segment corresponding to a starting trick play boundary point indicated by the metadata such as timecode 6687.5034. For example, the determined segment may be the ending content segment corresponding to the ending trick play boundary point indicated by the metadata such as timecode 12920.557823.

The duration of the trick play operation may be determined based on user input, determined by the user device 202, determined by the computing device 204, and/or stored in the metadata of the database 214. For example, the computing device 204 may determine the duration of the trick play operation based on the metadata received from the database 214 based on the query sent at processing flow 306. The computing device 204 may calculate a difference between trick play boundary points indicated by the metadata. As an example, the computing device 204 may calculate the difference to be 6133 milliseconds based on the difference between the starting boundary point of 6687.5034 and the ending boundary point 12920.557823 of the first set of time play boundary points indicated by the metadata. The sets of time play boundary points may be arranged as instances of a JavaScript Object Notation (JSON) list in the metadata stored in the database 214, for example. As an example, based on the duration of the trick play operation indicated by the metadata being 6133 milliseconds, the computing device 204 may determine that 4 fragments (each of a 2 second duration) are subject to the indicated type of trick play operation. The 4 fragments may be the dynamically determined quantity, number, and/or identity of fragments or segments that correspond to sets of trick play boundary points indicated by the metadata. For example, if the indicated type of trick play operation indicated by the metadata is a skip trick play operation, the 4 fragments may be removed to generate the custom manifest file that implement trick play automation. Based on the timecodes of the first set of time play boundary points, the indicated skip trick play operation may start at 6 seconds after the movie content item starts, such as based on the starting timecode of 6687.5034, which may function as the starting boundary point of the indicated skip trick play operation. Based on the quantity of 4 fragments determined by the computing device 204, the custom manifest file may be conditioned to skip the 4 fragments after the starting time code of 6687.5034, such as via trick play automation points.

The 4 fragments may correspond to the determined difference of 6133 milliseconds. Because the 4 fragments represent a total duration of 8 seconds based on the 2 second fragment duration for each fragment, the custom manifest file may be conditioned to restart the movie content item after the skip trick play operation at 14 seconds from the beginning of the movie. The 14 seconds endpoint (e.g., a clock time) may be determined based on the starting boundary point of 6687.5034 plus four fragments. The 14 second endpoint may be the ABR equivalent in the custom manifest file of the ending boundary point 12920.557823 (of the first set of time play markers indicated by the metadata) in the source manifest file. In this way, the first set of trick play boundary points and the associated trick play operation indicated by the metadata may be automatically implemented and applied by the custom manifest file determined by the computing device 204. For all of the sets of trick play boundary points indicated by the metadata, the computing device 204 may determine the equivalent ABR trick play automation points (e.g., starting and ending automation points of the custom manifest file) and apply the indicated type of trick play operation to generate the custom manifest file. In this way, the generated custom manifest file sent back to the user device 202 implements trick play automation.

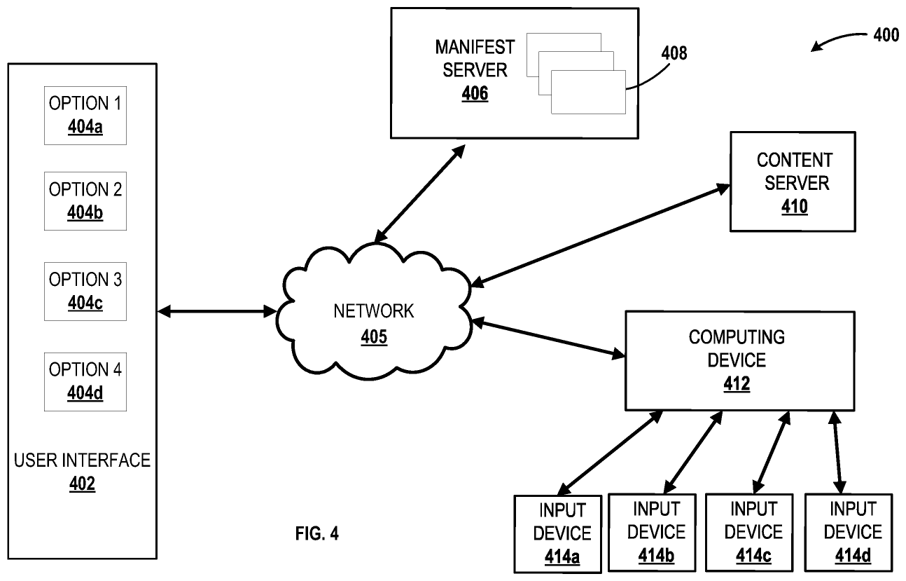

FIG. 4 illustrates various aspects of an example environment 400 in which the present methods and systems can operate. The environment 400 is relevant to systems and methods for trick mode automation applied to content items provided by a content provider. The example environment 400 may include a user interface 402 in communication with a network 405 to receive indications of custom manifest files, such as options 1 through 4 404a, 404b, 404c, 404d. The user interface 402 may be rendered by a user device such as user device 202. The user interface may display the options 404a, 404b, 404c, 404d as different content profiles and/or custom manifest files comprising different types of trick play automation points. For example, the options 404a, 404b, 404c, 404d may be a no violence custom manifest file, no swear words custom manifest file, rewind musical content custom manifest file, for example. For example, the options 404a, 404b, 404c, 404d may be a no violence content profile, no swear words content profile, rewind music content profile, for example. The manifest server 406 may store a plurality of created custom manifest files 408 based on user or crowd sourced trick play boundary points. For example, the manifest server 406 may store content profiles containing the boundary points. The content profiles may cause creation of custom manifest files based on the contained boundary points or the content profile may comprise the created custom manifest files. For example, the manifest server 406 may comprise a database, memory, or other storage to include versions of custom manifest files that are various conditioned versions of an original manifest file for each content item of a plurality of content items. A user profile associated with the user interface 402 may be used to determine which custom manifest files are used to present the options 404a, 404b, 404c, 404d.

For example, the user profile may be used to determine a user preference for a type of custom manifest file. For example, the user profile may be used to determine usage data that indicates what content has historically been output and been subject to a trick play operation on the user device. For example, the user profile may be used to determine custom manifest file options that have been presented to friends and/or family of the user viewing the user interface 402. Depending on the user profile, a subset of the plurality of created custom manifest files 408 and/or content profiles may be selected for presentation of the options 404a, 404b, 404c, 404d on the user interface 402. The user interface 402 may be used to select one of the options 404a, 404b, 404c, 404d. The selected option may be communicated to a content server 410 via a network 405. The content server 410 may send content to a user device associated with the user interface 402 according to the selected option. As an example, the content server 410 may send streaming content to the user device with a selected custom manifest file that includes trick play automation points. The trick play automation points may cause a specified type of trick play operation to be applied at the trick play automation points when the content is output at the user device. The plurality of created custom manifest files 408 may be created based on crowd sourced trick play boundary points received from a plurality of input devices 414a, 414b, 414c, 414d or user sourced trick play boundary points.

The plurality of input devices 414a, 414b, 414c, 414d may be in communication with a computing device 412, such as a middleware application, to determine specific segments in a manifest file corresponding to the determined crowd sourced trick play boundary points. The computing device 412 may compare a difference in clock times corresponding to the determined crowd sourced trick play boundary points with specific segments in the manifest file. For example, the computing device 412 may determine specific content segments in the source manifest file that correspond to the received trick mode markers based on a segment duration (e.g., a calculated fragment duration of the content item) and a duration of the trick play operation. As an example, the computing device 412 may compare the difference in clock time associated with the trick mode markers to the segment duration. This way, the computing device 412 may determine a number or quantity of segments (e.g., each having the segment duration). The computing device 412 may determine, based on the quantity of segments, trick play automation points associated with the trick play boundary points.

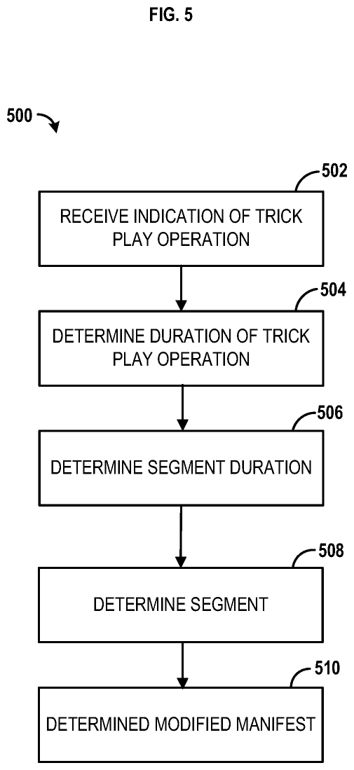

FIG. 5 shows a flowchart illustrating an example method 500 for trick mode automation. The method 500 may be implemented using the devices shown in FIGS. 1-2. For example, the method 500 may be implemented using a device such as the computing device 204. At step 502, a computing device may receive an indication of a trick play operation. The trick play operation may comprise a first timecode and a second timecode. The trick play operation may be associated with a content item. The computing device may receive, from a user device (e.g., the user device 202) or a plurality of user devices, at least one of: a machine learning classifier (e.g., a trick play classifier), a trick play marker, or closed captioning text. For example, the user device may provide user defined trick play information and the plurality of user devices may provide crowd sourced trick play information. The computing device may determine a profile indicative of a first timecode and a second timecode. The profile may be a user profile for or one or more content profiles selected by each user device, for example. The computing device may determine, based on the profile, a type of the trick play operation. The type of the trick play operation comprises at least one of: a fast forward operation, a rewind operation, a skip operation, or a mute operation.

At step 504, the computing device may determine a duration of the trick play operation. For example, the computing device may determine the duration of the trick play operation based on the first timecode and a second timecode. A difference in clock time associated with the first timecode and the second timecode may be compared with corresponding segments (e.g., segment duration) of a manifest file for the content. The duration of the trick play operation may be determined to identify specific segments corresponding to boundary points of the trick play operation. For example, the comparison of clock time and corresponding segments may be performed to determine the specific segments for creation of a custom manifest file with trick play automation points corresponding to the specific segments. For example, the trick play operation may be applied to content at the trick play boundary points. Specific segments corresponding to the trick play boundary points of the manifest file may be determined in order to determine trick play automation points. The duration of the trick play operation may be indicated by metadata stored in a database such as the database 214. For example, the computing device may send, to a database, a query for metadata. As an example, the metadata may comprise a plurality of timecodes associated with another trick play operation.

The computing device may receive, from the database, the metadata. The query for the metadata may be based on a request for a content item. For example, the computing device may receive, from the user device associated with the indication of the trick play operation, a request for the content item. As an example, the type of the trick play operation may be defined by the user device. At step 506, the computing device may determine a segment duration associated with each segment of a plurality of segments of the content item. The computing device may determine the segment duration based on a manifest associated with the content item, such as via a fragment duration specified by the manifest. For example, the manifest may be a source manifest file. For example, the source manifest file may specify a fixed duration of each segment during playback of the content item according to the source manifest file.

At step 508, the computing device may determine a segment of the plurality of segments associated with the duration of the trick play operation. The computing device may determine the segment based on the segment duration and the duration of the trick play operation. For example, the computing device may determine a difference between the first timecode and the second timecode. The computing device may determine an endpoint of the trick play operation. The endpoint may be determined based on the clock time and the difference. At step 510, the computing device may determine a modified manifest associated with the content item. The computing device may determine the modified manifest based on the segment and the manifest. As an example, the computing device may determine another segment of the plurality of segments that comprises an endpoint of the trick play operation. As an example, the computing device may determine a subset of the plurality of segments associated with application of the trick play operation. As an example, the computing device may remove the subset of the plurality of segments. For example, the computing device may apply the trick play operation. As an example, the trick play operation may be indicated by metadata stored in the database. The computing device may send, based on the user device being associated with the indication of the trick play operation, the modified manifest. For example, the modified manifest may be sent to the user device.

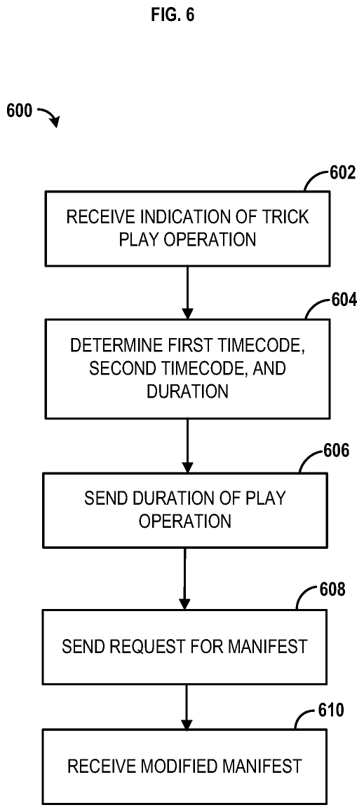

FIG. 6 shows a flowchart illustrating an example method 600 for trick mode automation. The method 600 may be implemented using the devices shown in FIGS. 1-2. For example, the method 600 may be implemented using a device such as the user device 202. At step 602, a computing device may receive an indication of a trick play operation. The trick play operation may be associated with a content item. The indication of the trick play operation may be from a user device (e.g., the user device 202) or a plurality of user devices. For example, the user device may provide user defined trick play information and the plurality of user devices may provide crowd sourced trick play information. At step 604, the computing device may determine a first timecode associated with the content item, a second timecode associated with the content item, and a duration of the trick play operation. The determination may be based on the indication of the trick play operation. For example, the computing device may determine the duration of the trick play operation based on the first timecode and the second timecode. The first timecode or the second timecode may comprise at least one of: a machine learning classifier, a trick play marker, or closed captioning text. The computing device may determine a profile indicative of the first timecode and the second timecode. The profile may be a user profile for each user device, for example. The computing device may determine, based on the profile, a type of the trick play operation. The type of the trick play operation may comprise at least one of: a fast forward operation, a rewind operation, a skip operation, or a mute operation.

At step 606, the computing device may send the duration of the trick play operation to another computing device. For example, the duration of the trick play operation may be sent to data storage, such as a database (e.g., database 214). As an example, the another computing device may send metadata comprising a plurality of timecodes associated with another trick play operation. The another computing device may comprise at least one of: a user device, a content playback device, or a mobile device. The another computing device may generally send trick mode information to be saved as metadata. The duration of the trick play operation may be stored as metadata in the database. The first timecode and the second timecode as well as other trick mode information may be stored as metadata in the database. For example, the another computing device may send, to the database, a query for metadata. As an example, the metadata may comprise a plurality of timecodes associated with another trick play operation.

The computing device may receive, based on the query and from the database, the metadata. As an example, the query for the metadata may be based on a request for a content item sent from the another computer device and received by the computing device. As an example, the request for the content item may comprise the another computing device sending a request for a manifest uniform resource locator (URL). For example, the computing device may intercept and receive the manifest URL. As an example, the computing device may send at least one of: an original source manifest file, data from a conditional data network, or a conditioned manifest file. For example, the computing device may receive, from the user device associated with the indication of the trick play operation, a request for the content item. As an example, the type of the trick play operation may be defined by the user device.

At step 608, the computing device may send a request for a manifest associated with the content item (e.g., the corresponding original source manifest file). The request for the source manifest file may be based on the request for the content item. The another computing device may determine a segment duration. For example, the segment duration may be associated with each segment of a plurality of segments of the content item. The another computing device may determine the segment duration based on the manifest associated with the content item. For example, the manifest may be the source manifest file. As an example, the computing device may determine a segment of the plurality of segments associated with the duration of the trick play operation. The computing device may determine the segment based on the segment duration and the duration of the trick play operation. For example, the computing device may determine a difference between the first timecode and the second timecode. The computing device may determine an endpoint of the trick play operation. The endpoint may be determined based on the clock time and the difference.

At step 610, the computing device may receive a modified manifest associated with the content item. For example, the modified manifest may be a conditioned version of the source manifest file, such as a custom manifest file. As an example, the another computing device may determine the modified manifest based on the segment and the manifest associated with the content item. As an example, the another computing device may determine the modified manifest based on the determined segment duration and the duration of the trick play operation. For example, the computing device may receive the modified manifest based on the computing device being associated with the indication of the trick play operation. The computing device may determine the modified manifest. As an example, the computing device may determine another segment of the plurality of segments that comprises an endpoint of the trick play operation. As an example, the computing device may determine a subset of the plurality of segments associated with application of the trick play operation. As an example, the computing device may remove the subset of the plurality of segments. For example, the computing device may apply the trick play operation. As an example, the trick play operation may be indicated by metadata stored in the database. The computing device may send, based on the user device being associated with the indication of the trick play operation, the modified manifest. For example, the modified manifest may be sent to the user device.

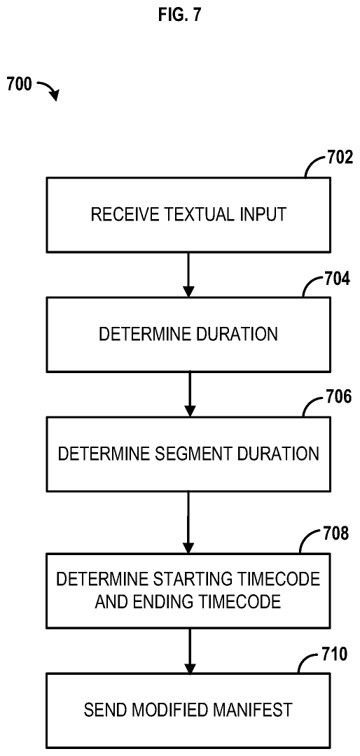

FIG. 7 shows a flowchart illustrating an example method 700 for trick mode automation. The method 700 may be implemented using the devices shown in FIGS. 1-2. For example, the method 700 may be implemented using a device such as the computing device 204. At step 702, a computing device may receive a textual input. For example, the textual input may be associated with a type of trick play operation. For example, the textual input may be a word, phrase, and/or the like. For example, the word may be a portion of closed captioning text associated with a content item being output by the computing device. The word may be part of a text string corresponding to text associated with the content item, such as dialogue stated by a character, text that appears in the scene (e.g., a sign held by a character), and/or the like. As an example, the word may be provided by a user or crowd sourced from multiple users for application of a trick play operation at trick play boundary points corresponding to the word. The trick play operation may be a fast forward or rewind operation automatically applied at the boundary points indicated by or associated with the word. A custom manifest file may be generated that has trick play automation points for automatic fast forward or rewind at the automation points which correspond to the trick play boundary points. The trick play operation may be associated with the content item. The trick play operation may comprise a first timecode and a second timecode. The computing device may receive the first timecode and the second timecode from a user device (e.g., the user device 202) or a plurality of user devices. For example, the user device may provide user defined trick play information and the plurality of user devices may provide crowd sourced trick play information. The first timecode or the second timecode may comprise at least one of: a machine learning classifier, a trick play marker, or closed captioning text. The computing device may determine a profile indicative of the first timecode and the second timecode. The profile may be a user profile for each user device, for example. The computing device may determine, based on the profile, a type of the trick play operation. The type of the trick play operation comprises at least one of: a fast forward operation, a rewind operation, a skip operation, or a mute operation.

At step 704, the computing device may determine a duration of the trick play operation. For example, the computing device may determine the duration of the trick play operation based on the word. For example, the computing device may determine the duration of the trick play operation based a first timecode and a second timecode associated with the word. The duration of the trick play operation may be stored as metadata in a database such as the database 214. The computing device may request trick play information from the database. For example, the computing device may send, to the database, a query for metadata. As an example, the metadata may comprise a plurality of timecodes associated with another trick play operation. The computing device may receive, from the database, the metadata. The query for the metadata may be based on a request for a content item. For example, the computing device may receive, from the user device associated with the indication of the trick play operation, a request for the content item. As an example, the type of the trick play operation may be defined by the user device.

At step 706, the computing device may determine a segment duration associated with each segment of a plurality of segments of the content item. The computing device may determine the segment duration based on a manifest associated with the content item. For example, the manifest may be a source manifest file. The computing device may determine a segment of the plurality of segments associated with the duration of the trick play operation. The computing device may determine the segment based on the segment duration and the duration of the trick play operation. For example, the computing device may determine a difference between the first timecode and the second timecode. The computing device may determine an endpoint of the trick play operation. The endpoint may be determined based on the clock time and the difference. At step 708, the computing device may determine a starting timecode and an ending timecode. The computing device may determine the starting timecode and the ending timecode based on the determined segment duration and the determined duration of the trick play operation. As an example, the computing device may send the query for the metadata in which the metadata comprises a plurality of machine learning classifiers. The computing device may receive the plurality of machine learning classifiers. The computing device may determine, based on the received plurality of machine learning classifiers, the starting timecode and the ending timecode.

At step 710, the computing device may send a modified manifest associated with the content item. The computing device may send the modified manifest based on the starting timecode, the ending timecode, and the manifest. The computing device may determine the modified manifest based on the segment and the manifest. As an example, the computing device may determine another segment of the plurality of segments that comprises an endpoint of the trick play operation. As an example, the computing device may determine a subset of the plurality of segments associated with application of the trick play operation. As an example, the computing device may remove the subset of the plurality of segments. For example, the computing device may apply the trick play operation. As an example, the trick play operation may be indicated by metadata stored in the database. As an example, the trick play operation may be user defined or crowd sourced. The computing device may send, based on the user device being associated with the indication of the trick play operation, the modified manifest. For example, the modified manifest may be sent to the user device.

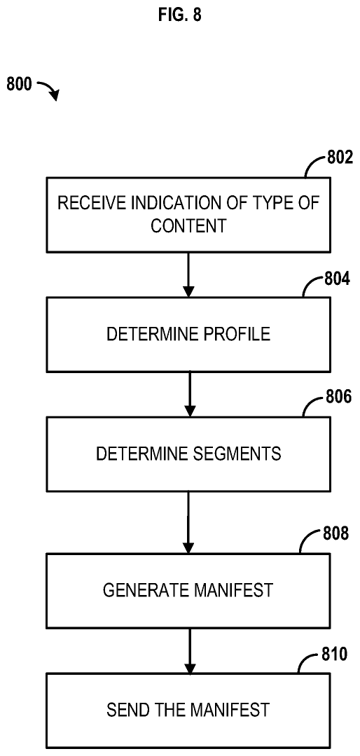

FIG. 8 shows a flowchart illustrating an example method 800 for trick mode implementation. The method 800 may be implemented using the devices shown in FIGS. 1-2. For example, the method 800 may be implemented using a device such as the computing device 204. At step 802, a computing device may receive an indication of a type of content to exclude from a content item. The computing device may receive the indication from a user device. As an example, the computing device may receive an indication of at least one of: a violent content type, a sexual content type, a vulgar content type, a language content type, a commercial content type, or a musical content type. As an example, the computing device may receive a plurality of types of content. As an example, the computing device may determine a plurality of profiles associated with the content item. The plurality of profiles may indicate boundary points of a plurality of portions of the content item. For example, the computing device may determine the plurality of segments based on the indicated boundary points of the plurality of portions of the content item. For example, the computing device may receive an indication of a trick play operation comprising at least one of: a skip operation or a fast forward operation. At step 804, the computing device may determine a profile associated with the content item. The profile may be determined based on the indication of the type of content. The profile may indicate boundary points of a portion of the content item.

At step 806, the computing device may determine a plurality of segments of the portion of the content item. The plurality of segments may be determined based on the indicated boundary points. The indicated boundary points may correspond to a start time point and a stop time point. Each segment of the plurality of segments may be associated with a segment duration. For example, the computing device may receive an indication of the segment duration based on a query to a database for metadata. As an example, the computing device may determine a difference between the start time point and the stop time point. The start time point and/or the stop time point may be associated with the indicated boundary points. For example, the start time point may be a clock time associated with a starting boundary point of a pair of boundary points. For example, the stop time point may be another clock time associated with an ending boundary point of the pair of boundary points. As an example, the start time point and the stop time point may span a portion of the content item corresponding to five minutes after playback of the content item started to fifteen minutes after playback of the content item started. The computing device may determine a trick play automation point associated with the start time point and the plurality of segments. The computing device may determine a quantity of the plurality of segments. The quantity of the plurality of segments may be determined based on the segment duration and the difference. For example, the computing device may determine the quantity of the plurality of segments based on determining corresponding identifiers of each segment of the plurality of segments. For example, the computing device may determine the quantity of the plurality of segments based on comparing the segment duration to the difference via the corresponding identifiers. As an example, the computing device may use the segment duration to determine how many segments are between the pair of boundary points according to the difference between the start time point and the end time point. The computing device may determine at least one trick play automation point. The at least one trick play automation point may be determined based on the quantity of the plurality of segments.

At step 808, the computing device may generate a manifest. The manifest may be generated based on the plurality of segments. As an example, the computing device may add the at least one trick play automation point to the manifest. The manifest may be configured to cause the user device to exclude (e.g. fast forward and/or skip) the portion of the content item. As an example, the computing device may associate the trick play operation with the plurality of segments. At step 810, the computing device may send the manifest to the user device. As an example, the computing device may send the manifest to the user device based on a request for the content item.

The computing device may determine at least one trick play automation point associated with additional boundary points and associated with an additional portion of the content item to exclude from the content item. The at least one trick play automation point may be determined based on a crowd sourced content profile. For example, the crowd sourced content profile may be used to mark additional scenes of the content item relative to boundary points previously received by the computing device. For example, the crowd sourced content profile may be used to exclude, from the content item, scenes of the same type as marked by a user. As an example, a parent may manually mark certain scenes of the content item that the parent does not desire their child to view, such as scenes corresponding to a classification such as Y7 which may be scenes of the content item that children under age seven should not view. The parent may inadvertently fail to manually mark scenes that should be classified as Y7 and should be subject to a trick play operation for exclusion from the content item. In this situation, the additional trick play boundary points may be determined based on crowd sourcing additional scenes that other parents believe should be classified as Y7. The additional trick play boundary points may mark additional portions of the content item that a group of parents indicate are unsuitable for children who are seven years old or younger.

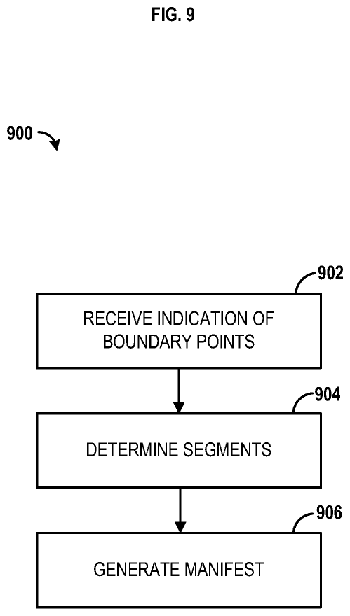

FIG. 9 shows a flowchart illustrating an example method 900 for trick mode implementation. The method 900 may be implemented using the devices shown in FIGS. 1-2. For example, the method 900 may be implemented using a device such as the computing device 204. At step 902, a computing device may receive an indication of boundary points associated with of a portion of a content item to exclude from the content item. As an example, the computing device may receive, from at least one user device, at least one of: a marking of at least one segment, an indication of a remote control operation, an indication of an interaction with an interface, a machine learning classifier, a user profile, a textual input, content usage data, content preference data, or closed captioning text. As an example, the computing device may receive an indication of a type of content. The type of content may comprise at least one of: a violent content type, a sexual content type, a vulgar content type, a language content type, a commercial content type, or a musical content type. As an example, the computing device may determine, based on the indication of the boundary points, a content profile comprising an indication of a trick play operation for a type of content. The trick play operation may comprise at least one of: a fast forward operation, a rewind operation, a skip operation, or a mute operation.

At step 904, the computing device may determine a plurality of segments. The plurality of segments may be determined based on the indicated boundary points. As an example, the computing device may determine that the indicated boundary points correspond to a start time point and a stop time point. The start time point and/or the stop end point may be associated with the indicated boundary points. For example, the start time point may be a clock time associated with a starting boundary point of a pair of boundary points. For example, the stop time point may be another clock time associated with an ending boundary point of the pair of boundary points. As an example, the start time point and the stop time point may span a portion of the content item corresponding to six seconds after a beginning of the content item started to fourteen second after the beginning of the content item. Each segment of the plurality of segments may be associated with a segment duration. For example, the computing device may receive an indication of the segment duration based on a query to a database for metadata. As an example, the computing device may determine a difference between the start time point and the stop time point. The computing device may determine a quantity of the plurality of segments. The quantity of the plurality of segments may be determined based on the segment duration and the difference. For example, the computing device may determine the quantity of the plurality of segments based on a determination of corresponding identifiers of each segment of the plurality of segments. For example, the quantity of the plurality of segments may be determined based on comparing the segment duration to the difference via the corresponding identifiers. As an example, the computing device may use the segment duration to determine how many segments are between the pair of boundary points according to the difference between the start time point and the end time point. The computing device may determine at least one trick play automation point. The at least one trick play automation point may be determined based on the quantity of the plurality of segments.

The computing device may determine at least one trick play automation point associated with additional boundary points and associated with an additional portion of the content item to exclude from the content item. The at least one trick play automation point may be determined based on a crowd sourced content profile. For example, the crowd sourced content profile may be used to mark additional scenes of the content item relative to boundary points previously received by the computing device. For example, the crowd sourced content profile may be used to exclude, from the content item, scenes of the same type as marked by a user. As an example, a parent may manually mark certain scenes of the content item that the parent does not desire their child to view, such as scenes corresponding to a classification such as Y7 which may be scenes of the content item that children under age seven should not view. The parent may inadvertently fail to manually mark scenes that should be classified as Y7 and should be subject to a trick play operation for exclusion from the content item. In this situation, the additional trick play boundary points may be determined based on crowd sourcing additional scenes that other parents believe should be classified as Y7. The additional trick play boundary points may mark additional portions of the content item that a group of parents indicate are unsuitable for children who are seven years old or younger. For example, the determined at least one trick play automation point may be associated with an additional portion of the content item to exclude from the content item.

At step 906, the computing device may generate a manifest associated with the content item. The manifest may be generated based on the plurality of segments. The manifest may be configured to exclude (e.g. fast forward and/or skip) the portion of the content item. The manifest may be generated based on the plurality of segments. As an example, the computing device may add the at least one trick play automation point to the manifest. The manifest may be configured to cause the at least one user device to exclude the portion of the content item. As an example, the computing device may send the manifest to the at least one user device based on a request for the content item.

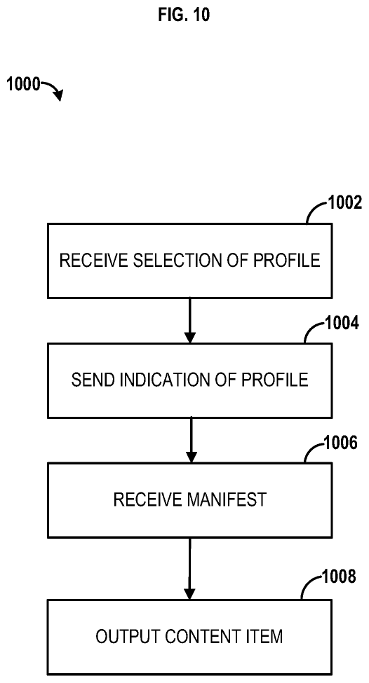

FIG. 10 shows a flowchart illustrating an example method 1000 for trick mode implementation. The method 1000 may be implemented using the devices shown in FIGS. 1-2. For example, the method 1000 may be implemented using a device such as the computing device 204. At step 1002, a computing device may receive a selection of a profile indicative of one or more portions of content to exclude from a content item. For example, the computing device may receive an indication of a type of content associated with the profile. The type of content may comprise at least one of: a violent content type, a sexual content type, a vulgar content type, a language content type, a commercial content type, or a musical content type. For example, the computing device may receive, from a plurality of user devices, an indication of a trick play operation configured to be applied to the one or more portions of content.

At step 1004, the computing device may send an indication of the profile. For example, the computing device may determine one or more boundary points of the one or more portions of content. The one or more boundary points may be determined based on at least one of: a previously selected trick play operation, usage associated with a user device, a machine learning classifier, a user profile, usage of a plurality of devices associated with the user device, a textual input, or a content preference associated with the user device. As an example, the computing device may determine, for the manifest, a trick play automation point associated with a start time point. The start time point may be associated with the one or more boundary points, such as indicated by the profile. That is, the start time point and/or the stop time point may be associated with the indicated one or more boundary points. For example, the start time point may be a clock time associated with a starting boundary point of the one or more boundary points indicated by the profile. For example, the start time point and stop time point may each be a clock time associated with a starting boundary point and an ending boundary point of the one or more boundary points, respectively. As an example, the start time point and the stop time point may span a portion of the content item corresponding to five minutes after playback of the content item started to fifteen minutes after playback of the content item started. As an example, the computing may determine trick play automation points associated with the start time point and the stop time point. The start time point and the stop time point may be associated with the one or more boundary points indicated by the profile. The indication of the profile may cause creation of a manifest associated with the content item. The manifest may be configured to cause the one or more portions of the content to be excluded.

At step 1006, the computing device may receive the manifest. As an example, the computing device may add at least one trick play automation point to the manifest. As an example, the computing device may determine a difference between the start time point and the stop time point. The computing device may determine a segment duration associated with a segment of a plurality of segments of the one or more portions of content. For example, the computing device may receive an indication of the segment duration based on a query to a database for metadata. The computing device may determine a quantity of the plurality of segments. The quantity of the plurality of segments may be determined based on the segment duration and the difference. For example, the computing device may determine the quantity of the plurality of segments based on a determination of corresponding identifiers of each segment of the plurality of segments. For example, the computing device may determine the quantity of the plurality of segments based on comparing the segment duration to the difference via the corresponding identifiers. As an example, the computing device may use the segment duration to determine how many segments are between the starting boundary point and an ending boundary point according to the difference between the start time point and the end time point. As an example, the computing device may determine at least one trick play automation point. The at least one trick play automation point may be determined based on the quantity of the plurality of segments.

At step 1008, the computing device may output the content item. The content item may be output based on the manifest. The one or more portions of the content may be excluded (e.g. fast forward and/or skip) from output. As an example, the computing device may apply a trick play operation to the one or more portions of the content at trick play automation points. The trick play operation may be applied based on the manifest. The trick play operation may comprise at least one of: a skip operation or a fast forward operation.

The computing device may determine at least one trick play automation point associated with additional boundary points and associated with an additional portion of the content item to exclude from the content item. The at least one trick play automation point may be determined based on a crowd sourced content profile. For example, the crowd sourced content profile may be used to mark additional scenes of the content item relative to boundary points previously received by the computing device. For example, the crowd sourced content profile may be used to exclude, from the content item, scenes of the same type as marked by a user. As an example, a parent may manually mark certain scenes of the content item that the parent does not desire their child to view, such as scenes corresponding to a classification such as Y7 which may be scenes of the content item that children under age seven should not view. The parent may inadvertently fail to manually mark scenes that should be classified as Y7 and should be subject to a trick play operation for exclusion from the content item. In this situation, the additional trick play boundary points may be determined based on crowd sourcing additional scenes that other parents believe should be classified as Y7. The additional trick play boundary points may mark additional portions of the content item that a group of parents indicate are unsuitable for children who are seven years old or younger. For example, the determined at least one trick play automation point may be associated with an additional portion of the content item to exclude from the content item.

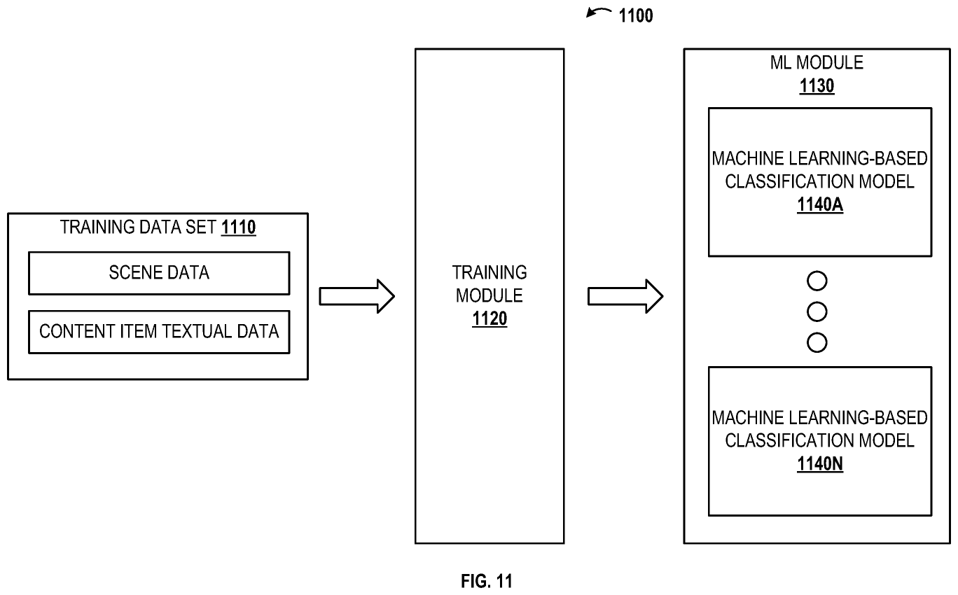

Methods are described herein using machine learning for trick mode automation such as via generating a predictive model. The methods may be executed via a computing device such as the computing device 204 of FIG. 2. FIG. 11 shows a flowchart illustrating an example method 1100 for a machine learning algorithm that implements trick mode automation. The methods described herein may use machine learning (“ML”) techniques to train, based on an analysis of one or more training data sets 1110 by a training module 1120 and at least one ML module 1130 that is configured to predict one or more trick mode operation for a given classifier, such as a fast forward trick mode operation, a rewind trick mode operation, a skip trick mode operation, a mute trick mode operation, and/or the like. The at least one ML module 1130 may predict boundary points associated with the one or more trick mode operations. The training module 1120 and at least one ML module 1130 may be components of or integrated into the computing device 204. A given classifier may be received from a user as an input to the machine learning algorithm. A classifier may indicate a user preference such as no violence, no blood, no deaths, no ghosts, no fights, no curse words, no sexual content, concise plot summary, repeat view, and/or the like. For example, a no violence classifier can refer to a preference to skip violent scenes in the content item, a concise plot summary classifier can refer to fast forwarding through certain scenes that can be considered boring or not relevant to a particular plot point or character, and a repeat view classifier can refer to rewinding to the beginning of an important scene so that a user can view the important scene again. Multiple users may each provide their respective classifier(s) to the at least one ML module 1130 so that the at least one ML module 1130 may execute a supervised machine learning model based on the multiple classifiers input.

The training data set 1110 may comprise a set of scene data and textual data (e.g., textual string) associated with one or more content items. The scene data comprises a series of component scenes of the content item and/or a descriptive tag such as a violence scene tag, a sexual scene tag, and/or the like. The textual data may comprise text strings or specific words (e.g., closed captioning text) related to content item, such as dialogue stated by a character, text that appears in the scene (e.g., a sign held by a character), and/or the like. A subset of the scene data and/or textual data may be randomly assigned to the training data set 1110 or to a testing data set. The assignment of data to a training data set or a testing data set may be random, completely random, or none of the above. Any suitable method or criteria (e.g., user provided classifiers) may be used to assign the data to the training or testing data sets, while ensuring that the distributions of yes and no labels are somewhat similar in the training data set and the testing data set.

The data of the training data set 1110 may be determined based on metadata associated with the one or more content items or information (e.g., machine learning inputs, trick play information) received from a database such as the database 214. The training data set 1110 may be provided to the training module 1120 for analysis and for determination of a feature set. The determination of the feature set may be determined based on user input, which may include user provided trick play classifiers. The feature set may be determined using the user input such that the size of the feature set is a proper fit. The feature set may comprise suggested or recommended words or phrases as well as associated trick play actions to be applied. The feature set may be determined by the training module 1120 via the ML module 1130. For example, the training module 1120 may train the ML module 1130 by extracting the feature set from a plurality of words, phrases and scenes (e.g., labeled as yes and thus subject to a trick play action) and/or another plurality of words, phrases and scenes (e.g., labeled as no and thus not subject to a trick play action) in the training data set 1110 according to one or more feature selection techniques.

The training module 1120 may train the ML module 1130 by extracting a feature set from the training data set 1110 that includes statistically significant features of positive examples (e.g., labeled as being yes) and statistically significant features of negative examples (e.g., labeled as being no). The training module 1120 may extract a feature set from the training data set 1110 in a variety of ways. The training module 1120 may perform feature extraction multiple times, each time using a different feature-extraction technique. As an example, the feature sets generated using the different techniques may each be used to generate different machine learning-based classification models 1140. For example, the feature set with the highest quality metrics may be selected for use in training.

The training module 1120 may use the feature set(s) to build one or more machine learning-based classification models 1140A-1140N that are configured to indicate whether a portion of a content item corresponding to a particular scene, word, or phrase is a candidate or suggested point for application of a trick play operation. The one or more machine learning-based classification models 1140A-1140N may also be configured to indicate the trick play boundary points or timecodes associated with the suggested trick play operation. Specific features of the feature set may have different relative significance in predicting trick play operation automation that a user will accept. For example, the presence of a knife may be strongly correlated with fast forward or skip trick play operation that a user inputting a no violence classifier will accept.

The training data set 1110 may be analyzed to determine any dependencies, associations, and/or correlations between features and the yes/no labels in the training data set 1110. The identified correlations may have the form of a list of features that are associated with different yes/no labels. The term “feature,” as used herein, may refer to any characteristic of an item of data that may be used to determine whether the item of data falls within one or more specific categories. By way of example, the features described herein may comprise text (e.g., words, phrases), character, particular scenes, objects, time points of a content item, and/or the like. A feature selection technique may comprise one or more feature selection rules. The one or more feature selection rules may comprise a feature occurrence rule. The feature occurrence rule may comprise determining which features in the training data set 1110 occur over a threshold number of times and identifying those features that satisfy the threshold as features.

A single feature selection rule may be applied to select features or multiple feature selection rules may be applied to select features. The feature selection rules may be applied in a cascading fashion, with the feature selection rules being applied in a specific order and applied to the results of the previous rule. For example, the feature occurrence rule may be applied to the training data set 1110 to generate a first list of features. A final list of features may be analyzed according to additional feature selection techniques to determine one or more feature groups (e.g., groups of features that may be used to predict trick play operation automation points). Any suitable computational technique may be used to identify the feature groups using any feature selection technique such as filter, wrapper, and/or embedded methods. One or more feature groups may be selected according to a filter method. Filter methods include, for example, Pearson's correlation, linear discriminant analysis, analysis of variance (ANOVA), chi-square, combinations thereof, and/or the like. The selection of features according to filter methods are independent of any machine learning algorithms. Instead, features may be selected on the basis of scores in various statistical tests for their correlation with the outcome variable (e.g., yes/no).

As another example, one or more feature groups may be selected according to a wrapper method. A wrapper method may be configured to use a subset of features and train a machine learning model using the subset of features. Based on the inferences that drawn from a previous model, features may be added and/or deleted from the subset. Wrapper methods include, for example, forward feature selection, backward feature elimination, recursive feature elimination, combinations thereof, and the like. As an example, forward feature selection may be used to identify one or more feature groups. Forward feature selection is an iterative method that begins with no feature in the machine learning model. In each iteration, the feature which best improves the model is added until an addition of a new variable does not improve the performance of the machine learning model.

As an example, backward elimination may be used to identify one or more feature groups. Backward elimination is an iterative method that begins with all features in the machine learning model. In each iteration, the least significant feature is removed until no improvement is observed on removal of features. Recursive feature elimination may be used to identify one or more feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 1120 has generated a feature set(s), the training module 1320 may generate a machine learning-based classification model 1140 based on the feature set(s). A machine learning-based classification model may refer to a complex mathematical model for data classification that is generated using machine-learning techniques. In one example, the machine learning-based classification model 1140 may include a map of support vectors that represent boundary features. By way of example, boundary features may be selected from, and/or represent the highest-ranked features in, a feature set. The machine learning-based classification model 1140 may be a supervised machine learning model based on a plurality of classifiers provided by a plurality of users.

The training module 1120 may use the feature sets determined or extracted from the training data set 1110 to build a machine learning-based classification model 1140A-1140N for each classification category (e.g., yes, no). In some examples, the machine learning-based classification models 1140A-1140N may be combined into a single machine learning-based classification model 1140. Similarly, the ML module 1130 may represent a single classifier containing a single or a plurality of machine learning-based classification models 1140 and/or multiple classifiers containing a single or a plurality of machine learning-based classification models 1140. A classifier may be provided by a user and may indicate a user preference such as no violence, no blood, no deaths, no ghosts, no fights, no curse words, no sexual content, concise plot summary, repeat view, and/or the like.

The features may be combined in a classification model trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting ML module 1130 may comprise a decision rule or a mapping for each feature to assign trick mode automation status.

In an embodiment, the training module 1120 may train the machine learning-based classification models 1140 as a convolutional neural network (CNN). The CNN comprises at least one convolutional feature layer and three fully connected layers leading to a final classification layer (softmax). The final classification layer may finally be applied to combine the outputs of the fully connected layers using softmax functions as is known in the art.

The feature(s) and the ML module 1130 may be used to predict the time points associated with one or more content items and corresponding types of trick play operations in the testing data set. As an example, the prediction result for each content item includes a likelihood that a specific scene of a particular content item comprises a point at which a trick play operation should be automatically applied. As an example, prediction result for each content item includes sets of time codes or boundary points at which a particular type of trick play operation should begin or end. The prediction result may have a confidence level that corresponds to a likelihood or a probability that a time point or portion is a trick play automation point. The confidence level may be a value between zero and one, and it may represent a likelihood that the time point or portion of the content item belongs to a trick play automation point.

For example, when there are two statuses (e.g., yes and no), the confidence level may correspond to a value p, which refers to a likelihood that a particular point or portion of the content item belongs to the first status (e.g., yes). In this case, the value 1−p may refer to a likelihood that the particular point or portion of the content item belongs to the second status (e.g., no). In general, multiple confidence levels may be provided for each particular point or portion of the content item in the testing data set and for each feature when there are more than two statuses. A top performing feature may be determined by comparing the result obtained for each trick play operation and corresponding automation point with the known yes/no status for each automation point. The known trick play automation point may be a trick play automation point that a user has specifically approved or explicitly provided as an input. In general, the top performing feature will have results that closely match the known trick play operation and automation point. The top performing feature(s) may be used to predict additional types of trick play automation and associated boundary or automation points. For example, a new automation boundary point or timecode may be determined/received. The new automation boundary point or timecode may be provided to the ML module 1130 which may, based on the top performing feature(s), classify the new automation boundary point or timecode of the content item as either a trick play automation point (yes) or not a trick play automation point (no).

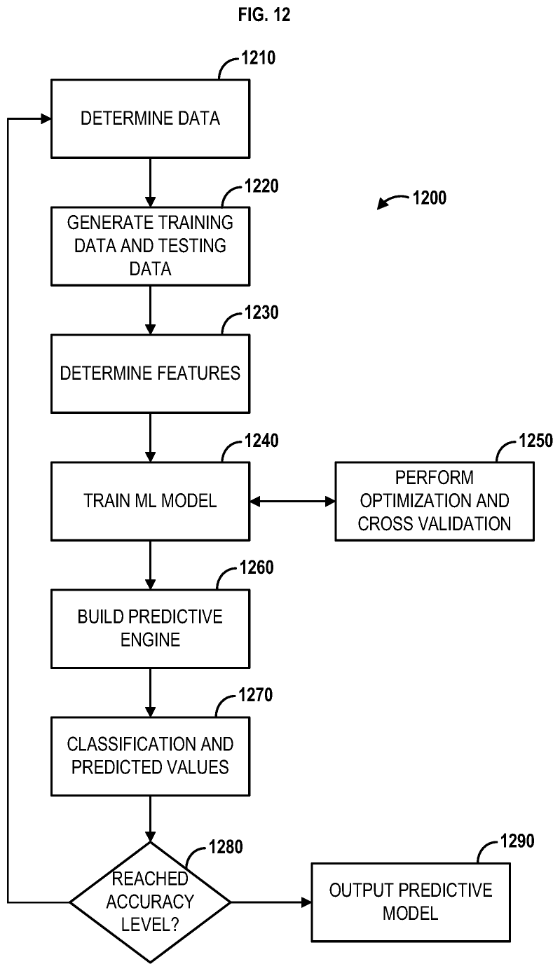

FIG. 12 is a flowchart illustrating an example training method 1200 for generating the ML module 1130 using the training module 1120. The training module 1120 can implement supervised, unsupervised, and/or semi-supervised (e.g., reinforcement based) machine learning-based classification models 1140. The method 1200 illustrated in FIG. 11 is an example of a supervised learning method; variations of this example of training method are discussed below, however, other training methods can be analogously implemented to train unsupervised and/or semi-supervised machine learning models.

The training method 1200 may determine (e.g., access, receive, retrieve, etc.) scene data and textual data associated with one or more content items at step 1210. The scene data and textual data may comprise a labeled set of words, phrases, and/or scenes of the one or more content items. The labels may correspond to trick play automation status (e.g., yes or no) and an associated type of trick play operation if the label corresponds to a trick play automation point.

The training method 1200 may generate, at step 1220, a training data set and a testing data set. The training data set and the testing data set may be generated by randomly assigning labeled set of words, phrases, and/or scenes to either the training data set or the testing data set. In some implementations, the assignment of labeled set of words, phrases, and/or scenes as training or testing data may not be completely random. As an example, a majority of the labeled set of words, phrases, and/or scenes may be used to generate the training data set. For example, 75% of the labeled set of words, phrases, and/or scenes may be used to generate the training data set and 25% may be used to generate the testing data set. In another example, 80% of the labeled set of words, phrases, and/or scenes may be used to generate the training data set and 20% may be used to generate the testing data set.

The training method 1200 may determine (e.g., extract, select, etc.), at step 1230, one or more features that can be used by, for example, a classifier to differentiate among different classification of trick play automation status (e.g., yes vs. no). As an example, the training method 1200 may determine a set of features from the labeled set of words, phrases, and/or scenes. As an example, a set of features may be determined from a labeled set of words, phrases, and/or scenes that is different than the labeled set of words, phrases, and/or scenes in either the training data set or the testing data set. In other words, the labeled set of words, phrases, and/or scenes may be used for feature determination, rather than for training a machine learning model. Such labeled set of words, phrases, and/or scenes may be used to determine an initial set of features, which may be further reduced using the training data set. By way of example, the features described herein may comprise text (e.g., words, phrases), character, particular scenes, objects, time points of a content item, and/or the like.

The training method 1200 may train one or more machine learning models using the one or more features at step 1240. In one example, the machine learning models may be trained using supervised learning. In another example, other machine learning techniques may be employed, including unsupervised learning and semi-supervised. The machine learning models trained at 1240 may be selected based on different criteria depending on the problem to be solved and/or data available in the training data set. For example, machine learning classifiers can suffer from different degrees of bias. Accordingly, more than one machine learning model can be trained at 1240, optimized, improved, and cross-validated at step 1250.

The training method 1200 may select one or more machine learning models to build a predictive model at 1260. The predictive model may be evaluated using the testing data set. The predictive model may analyze the testing data set and generate predicted trick play automation status statuses at step 1270. Predicted trick play automation status statuses may be evaluated at step 1280 to determine whether such values have achieved a desired accuracy level. Performance of the predictive model may be evaluated in a number of ways based on a number of true positives, false positives, true negatives, and/or false negatives classifications of the plurality of data points indicated by the predictive model.

For example, the false positives of the predictive model may refer to a number of times the predictive model incorrectly classified word, phrase, and/or scene as a trick play automation point that was in reality not a trick play automation point that should be recommended to a user or was not accepted by the user. Conversely, the false negatives of the predictive model may refer to a number of times the machine learning model classified a word, phrase, and/or scene as not a trick play automation point when, in fact, the word, phrase, and/or scene was a trick play automation point agreed to or input by a user. True negatives and true positives may refer to a number of times the predictive model correctly classified one or more trick play automation point as a trick play automation point or not a trick play automation point. Related to these measurements are the concepts of recall and precision. Generally, recall refers to a ratio of true positives to a sum of true positives and false negatives, which quantifies a sensitivity of the predictive model. Similarly, precision refers to a ratio of true positives a sum of true and false positives. When such a desired accuracy level is reached, the training phase ends and the predictive model (e.g., the ML module 1130) may be output at step 1290; when the desired accuracy level is not reached, however, then a subsequent iteration of the training method 1200 may be performed starting at step 1210 with variations such as, for example, considering a larger collection of automation boundary points.

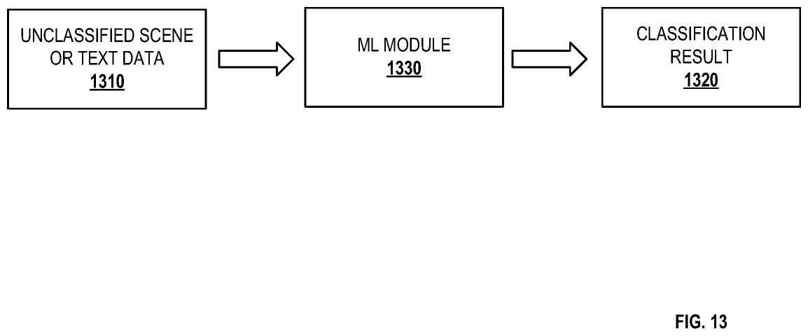

FIG. 13 is an illustration of an exemplary process flow for using a machine learning-based classifier to determine whether scene data or text data associated with a content item (e.g., word, phrase, and/or scene) is subject to a type of trick operation as a trick play automation point (e.g., at a specific boundary point or timecode). As illustrated in FIG. 13, unclassified scene data or text data 1310 may be provided as input to the ML module 1330. The ML module 1330 may process the unclassified scene data or text data 1310 using a machine learning-based classifier(s) to arrive at a classification result 1320.

The classification result 1320 may identify one or more characteristics of the unclassified scene data or text data 1310. For example, the classification result 1320 may identify the trick play automation status of the unclassified scene data or text data 1310 (e.g., whether or not the unclassified scene data or text data 1310 is likely to be a trick play boundary point or timecode and what type of trick play operation a user providing a specific classifier or having friends that provide a plurality of classifiers would want to apply at the boundary point or timecode).

The ML module 1330 may be used to classify a word, phrase, and/or scene provided by an analytical model for one or more content items. A predictive model (e.g., the ML module 1330) may serve as a quality control mechanism for the analytical model. Before a word, phrase, and/or scene provided by the analytical model is tested in an experimental setting, the predictive model may be used to test if the provided word, phrase, and/or scene would be predicted to be positive for trick play automation status. In other words, the predictive model may suggest or recommend that the provided word, phrase, and/or scene should be subject to a type of trick operation at a set of boundary points.

The recommended word, phrase, and/or scene as well as corresponding type of trick play operation and trick play boundary points may be used by a middleware device (e.g., the computing device 204) to create a conditioned version of a source manifest file (e.g., custom manifest file). As an example, a user may accept the (e.g., classification result 1320) of a machine learning algorithm (e.g., executed by the training module 1120 and ML module 1130) so that the middleware device intercepts a content item request from a user playback device and sends the custom manifest file having time markers and the associated type of trick play operation according to the classification result 1320.

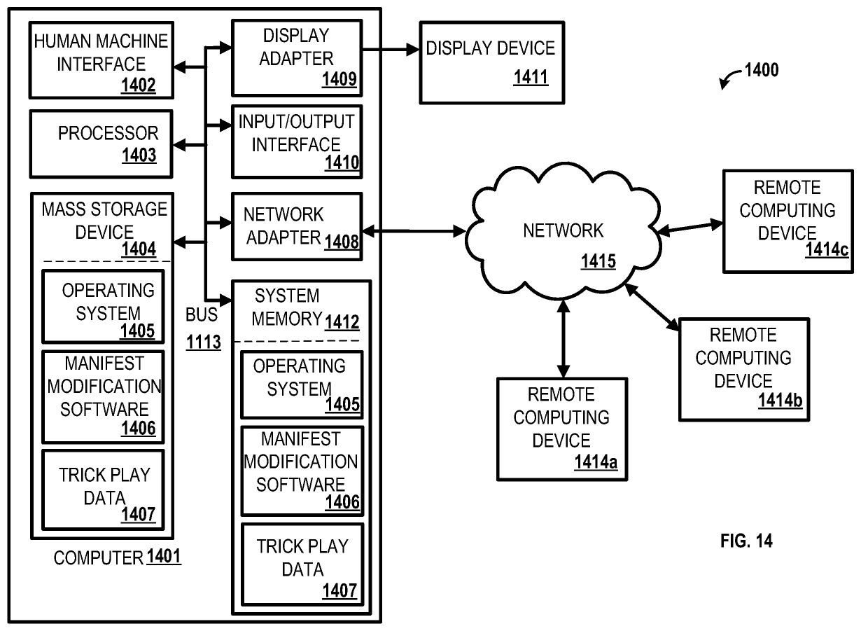

The methods and systems may be implemented on a computer 1401 as illustrated in FIG. 14 and described below. Similarly, the methods and systems disclosed may utilize one or more computers to perform one or more functions in one or more locations. FIG. 14 shows a block diagram illustrating an exemplary operating environment 1400 for performing the disclosed methods. This exemplary operating environment 1400 is only an example of an operating environment and is not intended to suggest any limitation as to the scope of use or functionality of operating environment architecture. Neither should the operating environment 1400 be interpreted as having any dependency or requirement relating to any one or combination of components illustrated in the exemplary operating environment 1400.

The present methods and systems may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems may be performed by software components. The disclosed systems and methods may be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods may also be practiced in grid-based and distributed computing environments where tasks are performed by remote processing devices that are linked through a communications network. In a distributed computing environment, program modules may be located in local and/or remote computer storage media including memory storage devices.

The user device 202, the computing device 204, and/or the database 214 of FIGS. 1-2 may be or include a computer 1401 as shown in the block diagram 1400 of FIG. 14. The computer 1401 may include one or more processors 1403, a system memory 1412, and a bus 1413 that couples various system components including the one or more processors 1403 to the system memory 1412. In the case of multiple processors 1403, the computer 1401 may utilize parallel computing. The bus 1413 is one or more of several possible types of bus structures, including a memory bus or memory controller, a peripheral bus, an accelerated graphics port, or local bus using any of a variety of bus architectures.

The computer 1401 may operate on and/or include a variety of computer readable media (e.g., non-transitory). The readable media may be any available media that is accessible by the computer 1401 and may include both volatile and non-volatile media, removable and non-removable media. The system memory 1412 has computer readable media in the form of volatile memory, such as random access memory (RAM), and/or non-volatile memory, such as read only memory (ROM). The system memory 1412 may store data such as the trick play data 1407 and/or program modules such as the operating system 1405 and the manifest modification software 1406 that are accessible to and/or are operated on by the one or more processors 1403.

The computer 1401 may also have other removable/non-removable, volatile/non-volatile computer storage media. FIG. 14 shows the mass storage device 1404 which may provide non-volatile storage of computer code, computer readable instructions, data structures, program modules, and other data for the computer 1401. The mass storage device 1404 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and/or the like.

Any quantity of program modules may be stored on the mass storage device 1404, such as the operating system 1405 and the manifest modification software 1406. Each of the operating system 1405 and the manifest modification software 1406 (or some combination thereof) may include elements of the program modules and the manifest modification software 1406. The manifest modification software 1406 may include processor executable instructions that cause determining a custom manifest file such as a condition version of a source manifest file. The custom manifest file may implement automation of an indicated trick play operation at indicated trick play marker points. The manifest modification software 1406 may include processor executable instructions that cause generation of the custom manifest file. The trick play data 1407 may also be stored on the mass storage device 1404. The trick play data 1407 may comprise at least one of: trick play operation may be a pause operation, fast forward operation, rewind operation, skip operation, reduce volume operation, mute operation, mute closed captions operation, and/or the like. The trick play data 1407 may be stored in any of one or more databases (e.g., database 214) known in the art. Such databases may be DB2®, Microsoft® Access, Microsoft® SQL Server, Oracle®, MySQL, PostgreSQL, and the like. The databases may be centralized or distributed across locations within the network 1415.

A user may enter commands and information into the computer 1401 via an input device (not shown). Examples of such input devices include, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1403 via a human machine interface 1402 that is coupled to the bus 1413, but may be connected by other interface and bus structures, such as a parallel port, game port, an IEEE 1394 Port (also known as a Firewire port), a serial port, network adapter 1408, and/or a universal serial bus (USB).

The display device 1411 may also be connected to the bus 1413 via an interface, such as the display adapter 1409. It is contemplated that the computer 1401 may include more than one display adapter 1409 and the computer 1401 may include more than one display device 1411. The display device 1411 may be a monitor, an LCD (Liquid Crystal Display), light emitting diode (LED) display, television, smart lens, smart glass, and/or a projector. In addition to the display device 1411, other output peripheral devices may be components such as speakers (not shown) and a printer (not shown) which may be connected to the computer 1401 via the Input/Output Interface 1410. Any step and/or result of the methods may be output (or caused to be output) in any form to an output device. Such output may be any form of visual representation, including, but not limited to, textual, graphical, animation, audio, tactile, and the like. The display device 1411 and computer 1401 may be part of one device, or separate devices.

The computer 1401 may operate in a networked environment using logical connections to one or more remote computing devices 1414a, 1414b, 1414c. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 1401 and a remote computing device 1414a, 1414b, 1414c may be made via a network 1415, such as a local area network (LAN) and/or a general wide area network (WAN). Such network connections may be through the network adapter 1408. The network adapter 1408 may be implemented in both wired and wireless environments. Such networking environments are conventional and commonplace in dwellings, offices, enterprise-wide computer networks, intranets, and the Internet.

Application programs and other executable program components such as the operating system 1405 are shown herein as discrete blocks, although it is recognized that such programs and components reside at various times in different storage components of the computing device 1401, and are executed by the one or more processors 1403 of the computer. An implementation of the manifest modification software 1406 may be stored on or sent across some form of computer readable media. Any of the described methods may be performed by processor-executable instructions embodied on computer readable media.

For purposes of illustration, application programs and other executable program components such as the operating system 1405 are illustrated herein as discrete blocks, although it is recognized that such programs and components may reside at various times in different storage components of the computing device 1401, and are executed by the one or more processors 1403 of the computer 1401. An implementation of manifest modification software 1406 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

While the methods and systems have been described in connection with specific examples, it is not intended that the scope be limited to the particular embodiments set forth, as the embodiments herein are intended in all respects to be illustrative rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice described herein. It is intended that the specification and examples be considered as exemplary only, with a true scope and spirit being indicated by the following claims.

1. A method comprising:
receiving, from a user device, an indication of a type of content to exclude from a content item;
determining, based on the indication, a profile associated with the content item, wherein the profile indicates boundary points of a portion of the content item;
determining, based on the indicated boundary points, a plurality of segments of the portion of the content item;
generating, based on the plurality of segments, a manifest, wherein the manifest is configured to cause the user device to exclude the portion of the content item; and
sending the manifest to the user device.

2. The method of claim 1, wherein receiving the indication of the type of content comprises receiving an indication of at least one of: a violent content type, a sexual content type, a vulgar content type, a language content type, a commercial content type, or a musical content type.

3. The method of claim 1, wherein receiving the indication of the type of content comprises receiving a plurality of types of content, wherein determining the profile associated with the content item comprises determining a plurality of profiles associated with the content item, and wherein the plurality of profiles indicates boundary points of a plurality of portions of the content item.

4. The method of claim 3, wherein determining the plurality of segments is based on the indicated boundary points of the plurality of portions of the content item.

5. The method of claim 1, wherein determining the profile comprises determining the indicated boundary points based on at least one of: usage associated with the user device, a machine learning classifier, a user profile, usage of a plurality of devices associated with the user device, a textual input, or a content preference associated with the user device.

6. The method of claim 1, wherein determining the plurality of segments comprises:
determining a difference between the start time point and the stop time point, wherein the indicated boundary points correspond to the start time point and the stop time point;
determining, based on a segment duration and the difference, a quantity of the plurality of segments, wherein each segment of the plurality of segments is associated with the segment duration; and
determining, based on the quantity of the plurality of segments, at least one trick play automation point.

7. The method of claim 6, wherein generating the manifest comprises adding the at least one trick play automation point to the manifest.

8. The method of claim 1, further comprising receiving an indication of a trick play operation comprising at least one of: a skip operation or a fast forward operation, and wherein generating the manifest comprises associating the trick play operation with the plurality of segments.

9. A method comprising:
receiving, by a computing device, an indication of boundary points associated with a portion of a content item to exclude from the content item;
determining, based on the indicated boundary points, a plurality of segments; and
generating, based on the plurality of segments, a manifest associated with the content item, wherein the manifest is configured to exclude the portion of the content item.

10. The method of claim 9, wherein receiving the indication of the boundary points comprises receiving, from at least one user device, at least one of: a marking of at least one segment, an indication of a remote control operation, an indication of an interaction with an interface, a machine learning classifier, a user profile, a textual input, content usage data, content preference data, or closed captioning text.

11. The method of claim 9, wherein determining the plurality of segments comprises determining that the indicated boundary points correspond to a start time point and a stop time point, and wherein each segment of the plurality of segments is associated with a segment duration.

12. The method of claim 11, wherein determining the plurality of segments comprises:
determining a difference between the start time point and the stop time point;
determining, based on the segment duration and the difference, a quantity of the plurality of segments; and
determining, based on the quantity of the plurality of segments, at least one trick play automation point.

13. The method of claim 9, further comprising determining, based on the indication of the boundary points, a content profile comprising an indication of a trick play operation for a type of content, wherein the trick play operation comprises at least one of: a fast forward operation, a rewind operation, a skip operation, or a mute operation.

14. The method of claim 9, further comprising determining, based on a crowd sourced content profile, at least one trick play automation point associated with additional boundary points and associated with an additional portion of the content item to exclude from the content item.

15. A method comprising:
receiving a selection of a profile indicative of one or more portions of content to exclude from a content item;
sending an indication of the profile, wherein the indication causes creation of a manifest associated with the content item, and wherein the manifest is configured to cause the one or more portions of the content to be excluded;
receiving the manifest; and
outputting, based on the manifest, the content item, wherein the one or more portions of the content are excluded from output.

16. The method of claim 15, wherein receiving the selection of the profile comprises receiving, from a plurality of user devices, an indication of a trick play operation configured to be applied to the one or more portions of content.

17. The method of claim 15, wherein sending the indication of the profile causes determining one or more boundary points of the one or more portions of content, wherein the one or more boundary points are determined based on at least one of: a previously selected trick play operation, usage associated with a user device, a machine learning classifier, a user profile, usage of a plurality of devices associated with the user device, a textual input, or a content preference associated with the user device.

18. The method of claim 15, sending the indication of the profile causes:
determining a difference between a start time point and a stop time point;
determining a segment duration associated with a segment of a plurality of segments of the one or more portions of content;
determining, based on the segment duration and the difference, a quantity of the plurality of segments; and
determining, based on the quantity of the plurality of segments, at least one trick play automation point.

19. The method of claim 15, wherein sending the indication of the profile causes determining a trick play automation point associated with a start time point and a stop time point, wherein the start time point and the stop time point are associated with boundary points indicated by the profile.

20. The method of claim 15, wherein outputting the content item comprises applying, based on the manifest, a trick play operation to the one or more portions of the content at trick play automation points, wherein the trick play operation comprises at least one of: a skip operation or a fast forward operation.
